(19) United States
(12) Patent Application Publication
(10) Pub. No.: US 2025/0124499 A1
(43) Pub. Date: Apr. 17, 2025

(54) METHOD FOR REFINANCING ARBITRAGE COLLATERALIZED LOAN OBLIGATIONS

(71) Applicant: KopenTech LLC, Los Angeles, CA (US)

(72) Inventors: James August Vogl, Los Angeles, CA (US); Anthony Schexnayder, Long Beach, CA (US); Olga Chernova, New York, NY (US); Anna Gryb, Los Angeles, CA (US); Alexander Gryb, Los Angeles, CA (US); Beniamin Airapetian, Kharkiv (UA); Charles Carey, New York, NY (US)

(21) Appl. No.: 18/990,847

(22) Filed: Dec. 20, 2024

Related U.S. Application Data
(63) Continuation-in-part of application No. 16/799,736, filed on Feb. 24, 2020, now abandoned.
(63) Continuation-in-part of application No. 18/385,869, filed on Oct. 31, 2023.
Application No. 18/385,869 is a continuation-in-part of application No. 17/829,240, filed on May 31, 2022, now abandoned.
Application No. 17/829,240 is a continuation-in-part of application No. 16/820,349, filed on Mar. 16, 2020, now abandoned.
Application No. 17/829,240 is a continuation-in-part of application No. 16/799,736, filed on Feb. 24, 2020, now abandoned.
(60) Provisional application No. 62/809,493, filed on Feb. 22, 2019.
(60) Provisional application No. 62/195,120, filed on Jul. 21, 2015.
(60) Provisional application No. 62/819,442, filed on Mar. 15, 2019.

(51) Int. Cl. G06Q 30/08; G06Q 40/03

(52) U.S. Cl. CPC G06Q 30/08; G06Q 40/03; G06Q 2220/00

(57) ABSTRACT

One variation of a method for refinancing arbitrage structured product investments comprising: receiving selection of a tranche—associated with an initial interest margin and containing an outstanding debt quantity—within a structured product investment by an initiator; assigning a target interest margin, less than the initial interest margin, to the tranche; initiating an online public auction for the outstanding debt quantity; during the online public auction, recording a set of bids submitted by a set of investors, each bid in the set specifying a debt quantity at the target interest margin; calculating a sum of debt quantities, at the target interest margin, specified in the set of bids; and, in response to the sum of debt quantities clearing the outstanding debt quantity upon conclusion of the online public auction, initiating settlement and redistribution of the outstanding debt quantity in the tranche according to the set of bids.

### CROSS-REFERENCE TO RELATED APPLICATIONS

This Application is a continuation-in-part Application of U.S. patent application Ser. No. 16/799,736, filed on 24 Feb. 2020, which claims the benefit of U.S. Provisional Patent Application No. 62/809,493, filed on 22 Feb. 2019, which is incorporated in its entirety by this reference.

This Application is a continuation-in-part Application of U.S. patent application Ser. No. 18/385,869, filed on 31 Oct. 2023, which is a continuation-in-part Application of U.S. patent application Ser. No. 17/829,240, filed on 31 May 2022, which: claims the benefit of U.S. Provisional Application No. 63/195,120, filed on 31May 2021; is a continuation-in-part application of U.S. patent application Ser. No. 16/820,349, filed on 16 Mar. 2020, which claims the benefit of U.S. Provisional Patent Application No. 62/819,442, filed on 15 Mar. 2019; and is a continuation-in-part application of U.S. patent application Ser. No. 16/799,736, filed on 24 Feb. 2020, which claims the benefit of U.S. Provisional Patent Application No. 62/809,493, filed on 22 Feb. 2019; each of which is incorporated in its entirety by this reference

### TECHNICAL FIELD

This invention relates generally to the field of structured financial products and more specifically to a new and useful method for refinancing arbitrage collateralized loan obligations in the field of structured financial products.

### BRIEF DESCRIPTION OF THE FIGURES

FIG. 1 is a flowchart representation of a method;

FIG. 2 is a flowchart representation of one variation of the method;

FIGS. 3A, 3B, and 3C are a flowchart representations of variations of the method;

FIG. 4 is a flowchart representation of one variation of the method;

FIG. 5 is a flowchart representation of one variation of the method;

FIG. 6 is a graphical representation of one variation of the method;

FIG. 7 is a graphical representation of one variation of the method; and

FIG. 8 is a graphical representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

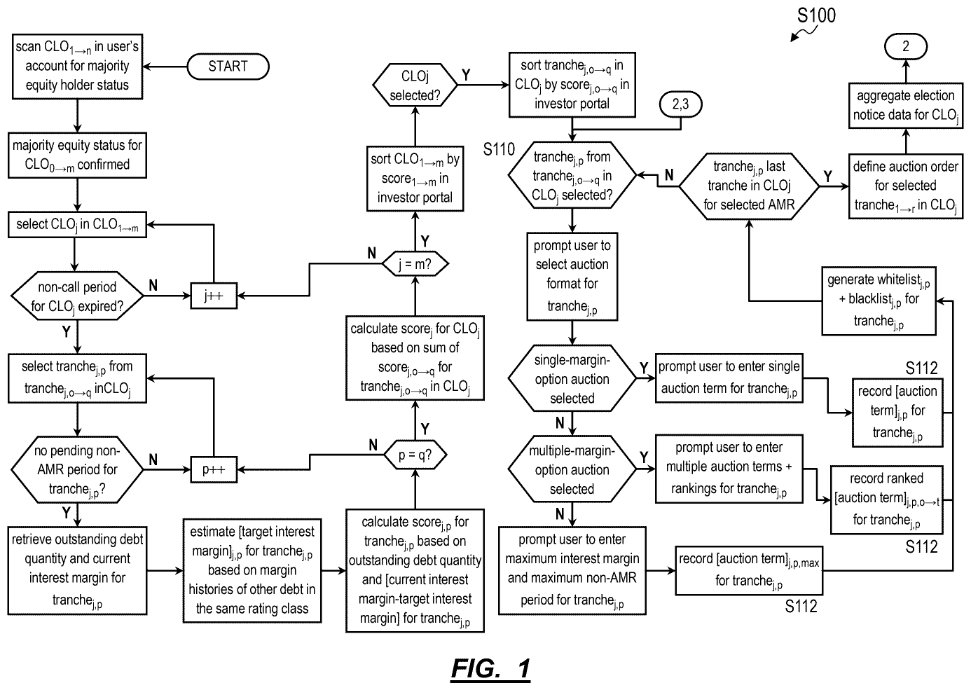

As shown in FIGS. 1, 2, 3A, 4, and 5, a method S100 for refinancing arbitrage structured product investments includes: receiving selection of a tranche of a structured product investment by an initiator affiliated with the structured product investment in Block S110; generating an election notice for applicable margin reset for the tranche based on a template election notice in Block S120; serving the election notice to a trustee associated with the structured product investment for distribution to debt holders holding debt in the structured product investment in Block S130; in response to confirmation of the election notice by the trustee, initiating an online public auction for debt in the tranche on an auction platform in Block S140; during the online public auction, recording a set of bids submitted by a set of broker-dealers on the auction platform in Block S142, each bid in the set of bids specifying a debt quantity for debt in the tranche at a new interest margin less than the current interest margin of the tranche; calculating a sum of debt quantities at the new interest margin submitted by the set of broker-dealers during the online public auction in Block S150; and, in response to the sum of debt quantities clearing an outstanding debt quantity of the tranche upon conclusion of the online public auction, initiating settlement and redistribution of debt in the tranche to the set of broker-dealers in Block S160.

One variation of the method S100 shown in FIGS. 1, 2, 3A, 4, and 5 includes: receiving selection of a first tranche, in a set of tranches within a structured product investment, by an initiator affiliated with the structured product investment at a first time in Block S110, the first tranche associated with an initial interest margin at the first time and containing a first outstanding debt quantity; assigning a first cap margin (or “target interest margin”), less than the initial interest margin, to the first tranche in Block S112; initiating an online public auction on an auction platform for the first outstanding debt quantity in the first tranche in Block S140; during the online public auction, recording a first set of bids submitted by a first set of investors via the auction platform in Block S142, each bid in the first set of bids specifying a debt quantity at the first cap margin; calculating a first sum of debt quantities, at the first cap margin, specified in the first set of bids in Block S150; and, in response to the first sum of debt quantities clearing the first outstanding debt quantity of the first tranche upon conclusion of the online public auction, initiating settlement and redistribution of the first outstanding debt quantity in the first tranche according to the first set of bids in Block S160.

Another variation of the method S100 shown in FIGS. 1, 2, 3C, 4, and 5 includes: receiving selection of a first tranche, in a set of tranches within a structured product investment, by an initiator affiliated with the structured product investment at a first time in Block S110, the first tranche associated with an initial interest margin at the first time and containing a first outstanding debt quantity; assigning a maximum interest margin, less than the initial interest margin, to the first tranche in Block S112; initiating an online public auction on an auction platform for the first outstanding debt quantity in the first tranche in Block S140; during the online public auction, recording a set of bids submitted by a set of investors via the auction platform in Block S142, each bid in the set of bids specifying a debt quantity and an interest margin; identifying a first subset of bids, in the set of bids, that specifies debt quantities that sum to a first aggregate debt quantity that clears the first outstanding debt quantity and that specifies interest margins skewed toward a lowest interest margin in the set of bids in Block S150; and, in response to interest margins specified in the first subset of bids clearing the maximum interest margin upon conclusion of the online public auction, initiating settlement and redistribution of the first outstanding debt quantity in the first tranche according to the first subset of bids in Block S160.

Yet another variation of the method S100 shown in FIGS. 1, 2, 3B, 4, and 5 includes: receiving selection of a first tranche, in a set of tranches within a structured product investment, by an initiator affiliated with the structured product investment at a first time in Block S110, the first tranche associated with an initial interest margin at the first time and containing a first outstanding debt quantity; defining a first auction term for the first tranche in Block S112, the first auction term specifying a first cap margin, less than the initial interest margin, and a first non-reset period; defining a second auction term for the first tranche in Block S112, the second auction term specifying a second cap margin, less than the first cap margin, and a second non-reset period different from the first non-reset period; initiating an online public auction on an auction platform for the first outstanding debt quantity in the first tranche in Block S140; during the online public auction, recording a first set of bids submitted by a first set of investors via the auction platform in Block S142, each bid in the first set of bids specifying a debt quantity according to the first auction term; during the online public auction, recording a second set of bids submitted by a second set of investors via the auction platform in Block S142, each bid in the second set of bids specifying a debt quantity according to the second auction term; calculating a first sum of debt quantities specified in the first set of bids submitted by the first set of investors during the online public auction in Block S150; calculating a second sum of debt quantities specified in the second set of bids submitted by the second set of investors during the online public auction in Block S150; and, in response to the first sum clearing the first outstanding debt quantity and in response to the second sum falling below the first outstanding debt quantity, initiating settlement and redistribution of the first outstanding debt quantity in the first tranche to the first set of investors according to the first set of bids, the first cap margin, and the first non-reset period in Block S160.

### 2. Applications

Generally, a computer system can execute Blocks of the method S100 to refinance one or more tranches in an arbitrage collateralized loan obligation (hereinafter the “CLO”) at lower margins by: generating an election notice when triggered by an initiator affiliated with the CLO (e.g., a majority equity holder of the CLO, a collateral manager affiliated with the CLO, or a majority coalition of equity holders of the CLO); distributing the election notice to the CLO's trustee for confirmation; notifying existing debt holders and broker-dealers of an auction for these tranches; hosting a public auction (e.g., a semi-public online auction accessible to whitelisted broker-dealers and individual investor on an auction platform) for remaining debt in these tranches; and selectively handling settlement and redistribution of debt in these tranches if bids recorded during the auction clear these tranches.

### 2.1 Traditional CLO Refinancing

A CLO is a structured investment product containing: assets, including a pool of secured loans to leveraged companies; and liabilities, including debt and equity tranches issued to purchase these secured loans. For example, a CLO may include one equity tranche and many debt tranches (e.g., AAA-, AA-, A-, BBB-, BB-, and B-rated debt tranches). A CLO may thus generate returns for equity tranche holders via “excess spread”—that is, a difference between the interest income received from these assets and the interest costs of these liabilities paid to debt tranche holders. CLO equity tranche holders may therefore receive increased returns by decreasing the interest costs (or interest margins, spread over LIBOR) paid to debt holders in debt tranches in the CLO—that is, by increasing excess spread. When the CLO debt market tightens (i.e., when interest rates drop) and after a non-call period of the CLO has passed, an initiator affiliated with the CLO may therefore wish to refinance the CLO in order to reduce interest rates for debt tranches in the CLO and thus increase excess spread for equity holders in the CLO. However, historically, to refinance even one debt tranche in a CLO, the CLO in its entirety is refinanced by retiring outstanding debt in the entire CLO, repackaging the assets in the CLO, and reissuing new CLO debt tranches, which triggers: underwriting costs for marketing the new CLO; rating agency costs for re-rating tranches of the new CLO; and legal costs for generating a new indenture. This process may span a relatively long period of time (e.g., months) due to extensive, staged, manual involvement across a variety of stakeholders and may thus incur high external costs such that market conditions may have changed (e.g., the market may have widened) sufficiently and such that refinancing if the CLO is no longer economical or desirable by the time the CLO is readied for refinancing.

Furthermore, to refinance a CLO under traditional processes, the majority equity holder or collateral manager of the CLO may hire an underwriter to aggregate offers that clear all tranches in the CLO. Original securities in the CLO may then be redeemed, and new debt is issued for the new CLO, which further requires a new indenture, triggers additional legal and listing costs, and necessitates that all tranches in the CLO be refinanced together. A majority equity holder or collateral manager may therefore delay refinancing a CLO such that opportunities to refinance evaporate (e.g., due to market changes) before the CLO can be successfully refinanced, thereby resulting in higher long-term costs and greater complexity for equity holders of the CLO. Such “market frictions” inherent in traditional CLO refinancing may therefore inhibit equity tranche holders from achieving higher excess returns and reduce investor access to debt in tranches in this CLO.

### 2.2 Automated Applicable Margin Reset

Conversely, the computer system can execute Blocks of the method S100 to automatically complete an applicable margin reset (or “AMR”) process that streamlines refinancing one debt tranche or a subset of debt tranches in a CLO, thereby: eliminating a need to redeem and reissue debt securities; eliminating a need to generate a new indenture; shortening the refinancing process (e.g., to as few as 5 days); and increasing transparency and access to CLO debt via public auction for debt tranches in the CLO. For example, when the market tightens (i.e., when market CLO debt interest rates decrease), a majority equity holder of the CLO may trigger the computer system to execute (or interface with an AMR agent and/or other human to complete) the AMR process for one or more tranches in the CLO, such as by selecting the CLO and tranches in this CLO from within an investor portal hosted by the computer system. (The computer system can also flag or highlight tranches in the CLO assigned non-call periods that have expired or are soon to expire and prompt the majority equity holder (or the collateral manager, or a majority coalition of equity holders) to select these tranches within the investor portal.) The computer system can then aggregate AMR parameters (or “auction terms”) from the majority equity holder via the investor portal, such as: tranches in the CLO to refinance; a maximum interest margin (or “cap margin”) for each listed tranche; and/or a non-call period and/or a non-reset period for each listed tranche. The computer system can also: automatically generate an election notice for the selected debt tranches in the CLO, such as by compiling these AMR parameters, CLO data, and a template election notice into a custom election notice for the selected tranches in this CLO; and return this election notice to the CLO's trustee for validation and distribution to debt holders and the CLO market according to the CLO's indenture. Once the election notice is verified by the trustee, the computer system can initiate a public auction for the selected tranches on an auction platform.

During this auction, participants (e.g., broker-dealers, who represent a population of debt investors and/or who represent their own books) on the auction platform may place bids for debt at particular interest margins (e.g., spread over LIBOR) and/or place bids for certain debt quantities in individual tranches of the CLO.

Upon conclusion of an auction for a debt tranche in this CLO, the computer system can verify success of this debt tranche auction based on whether an aggregate debt quantity of these bids clear the remaining debt in the tranche below a cap margin specified for the debt tranche by the majority equity holder or collateral manager. The computer system can: then calculate allocations for participating broker-dealers; and initiate settlement and debt redistribution for this debt tranche if results of this auction clear tranche size and interest margin requirements of this debt tranche.

The computer system can execute this process concurrently for multiple (or all) debt tranches in the CLO or for a single debt tranche in the CLO. The computer system can also execute instances of the process in series to sequentially auction individual debt tranches (e.g., A, then AA, then AAA . . . ) or individual groups of debt tranches (e.g., all C-debt tranches, then all B-debt tranches, then all A-debt tranches). Therefore, the computer system can execute Blocks of the method S100 to autonomously execute an AMR process for one or more tranches in a CLO when the majority equity holder or collateral manager of the CLO selects or confirms one, several, or all debt tranches in the CLO for refinancing.

Furthermore, because the computer system coordinates settlement and redistribution of entire tranches in the CLO, the computer system can preserve original debt in the CLO and the original indenture of the CLO, thereby: reducing or eliminating needs to re-rate the CLO debt tranches post-refinancing, to generate a new indenture for a new CLO, and to market debt in the CLO through an underwriter; reducing refinancing time; reducing rating, legal, and underwriting costs; and enabling greater debt tranche selectivity for refinancing. By hosting auctions for CLO debt in particular tranches on a public auction platform, the computer system can also increase transparency for CLO tranche margins, improve access to CLO debt for broker-dealers and investors, and improve excess spread for equity holders through lower CLO liabilities resulting from increased broker-dealer demand.

### 2.3 Terms

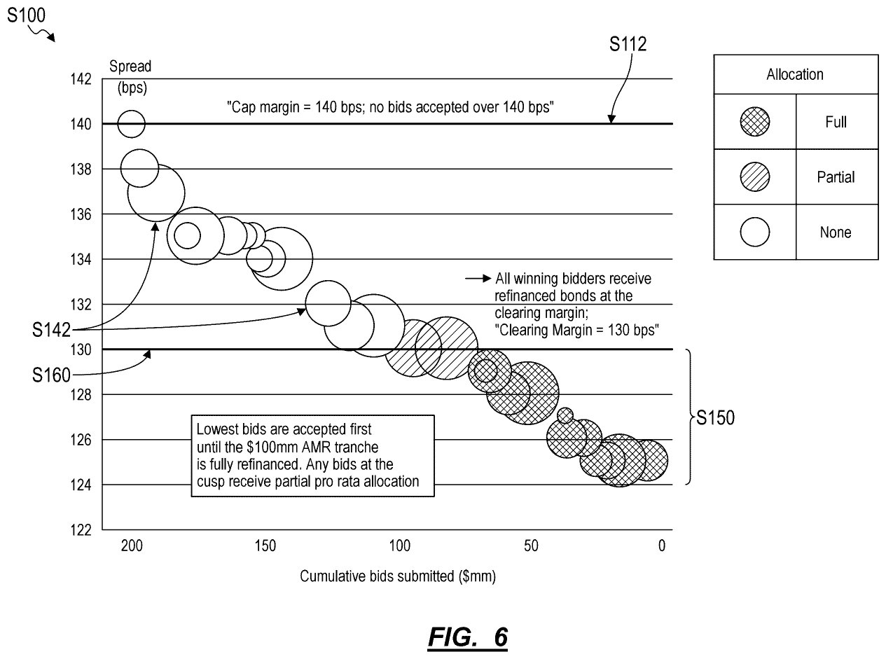

Generally, “interest margin” is referred to herein as a rate of annual interest paid to debt within a particular tranche in the CLO. “Cap margin” is referred to herein as a maximum bid margin accepted by the computer system for debt within a tranche during an auction on the auction platform. Furthermore, “clearing margin” is referred to herein as: a minimum margin that spans a subset of bids—in a population of bids entered by broker-dealers and/or individual investors during a debt tranche auction—that specify debt quantities that sum to a total current debt quantity of the tranche; and therefore corresponds to a final interest margin received by broker-dealers and/or individual investors who placed these bids, as shown in FIG. 6.

Generally, “Color” as described herein includes bid price, bid level, and/or general auction outcome data provided to bidders and/or published for the market more generally following conclusion of an auction. For example, “color” can include confirmation that a security “traded” or “did not trade” (or “DNT”) and the final bid price and bid level for this security.

Furthermore, the method S100 is described herein as executed by the computer system to refinance one, multiple, or all tranches within a new, reissue, or existing CLO. However, the method S100 can additionally or alternatively be executed by the computer system refinance one, multiple, or all tranches within new, reissue, or existing structured or securitized product investment, such as: asset-backed securities; commercial mortgage-backed securities; and/or residential mortgage-backed securities.

The method S100 is described herein as executed by a computing device to host debt tranche auctions in which broker-dealers bid—on behalf of debt investors—for debt in tranches in a CLO. However, the computer system can execute Blocks the method S100 to host debt tranche auctions in which individual debt investors—such as in addition to or instead of broker-dealers—bid for debt in tranches in a CLO.

Furthermore, the computer system can execute Blocks the method S100 to host time-limited “marketplaces,” “listings,” or other sale formats in which broker-dealers (or investors more generally) may place bids or claims for debt in a tranche in a CLO.

### 3. Auction Platform

The computer system can include a computer server or a computer network and can host an auction platform accessible by a large population of broker-dealers (e.g., both large and small broker-dealers and/or individual debt investors) to place bids for debt in CLO debt tranches. For example, the computer system can enable access to auctions on the auction platform via a native application or web browser executing on a desktop computer or mobile device.

The computer system can also maintain a global whitelist of verified broker-dealers permitted to place bids for CLO debt on the auction platform. The computer system can additionally or alternatively maintain a global blacklist of broker-dealers not permitted to place bids for CLO debt on the auction platform, such as broker-dealers who failed to settle bids for previous auctions on the platform. The computer system can also maintain global broker-dealer bid limits, such as in broker-dealer profiles for whitelisted broker-dealers and based on size and/or bid history of these broker-dealers.

The computer system can also host an investor portal accessible to a majority equity holder (or a collateral manager affiliated with the CLO or a coalition of equity holders of the CLO)—such as via a native application or web browser—to view CLOs in which the equity investor(s) holds majority interest and to trigger the computer system to selectively execute the AMR process for tranches in these CLOs.

The computer system can similarly host an electronic bidder portal—accessible by bidders via electronic devices—on a computer network. For example, the computer system can host an electronic bidder portal within a native application or web browser executing on a mobile or desktop computing device.

The computer system can also record electronic bids—entered via electronic bidder portals—in a local or remote database. Additionally or alternatively, the computer system can record electronic bids on a distribute ledge (e.g., on a “blockchain”). For example, the computer system can: receive an electronic bid, specifying a debt quantity at a particular cap margin, from an investor associated with an investor identifier; generate a set of bid metadata identifying the investor, the debt quantity, and the particular cap margin; encrypt the set of bid metadata; and initiate generation of a block containing the set of bid metadata on a blockchain for storage on a distributed electronic ledger.

### 4. AMR Initiation

Block S110 of the method S100 recites receiving selection of a tranche of a collateralized loan obligation by a majority equity holder of the collateralized loan obligation. Generally, a user may elect to initiate the AMR process for one or more tranches in a CLO in which she (or her firm) is the majority equity holder or for which she (or her firm) is the collateral manager; the computer system can record this trigger and initiate this AMR process accordingly in Block S110, as shown in FIG. 1.

In one implementation, when the user accesses the investor portal, the computer system: scans a set of CLOs for which the user is the majority equity holder; aggregates a subset of these CLOs for which a non-call period has expired (or is about to expire) and for which AMR is now available according to the indentures of these CLOs; and presents this subset of CLOs to the user via the investor portal. In this implementation, the computer system can also rank this subset of CLOs by excess spread, time of last successful refinance via the AMR process, last attempted refinance, etc. The computer system can then prompt the user—via the investor portal—to select a particular CLO from this subset and to select one or more tranches in the selected CLO to refinance.

When the user then selects a CLO, a subset of tranches in a CLO, or a particular tranche in a CLO to refinance, the computer system can record this intent to refinance this tranche in Block S110 and then collect additional auction parameters for the CLO and the selected tranche(s).

### 4.1 Ranked Tranches

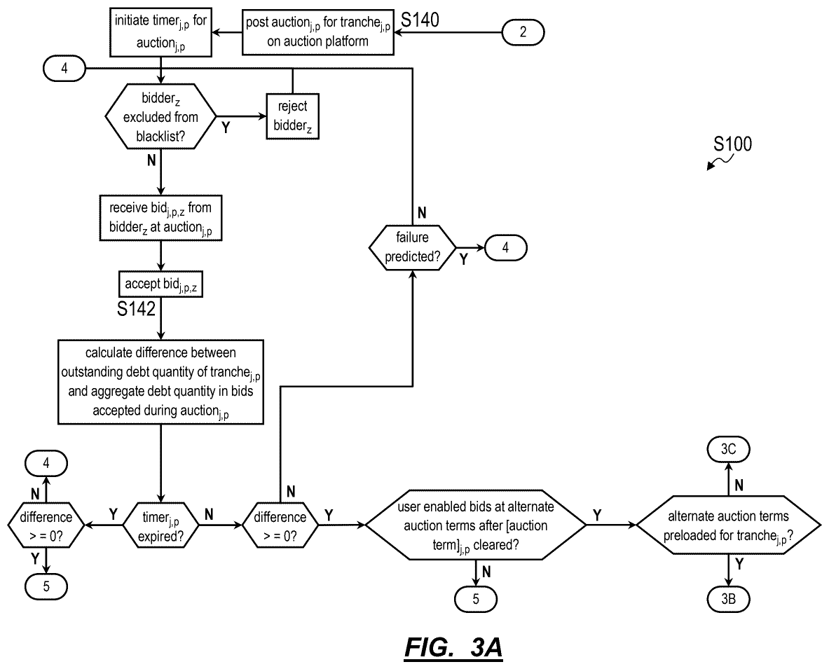

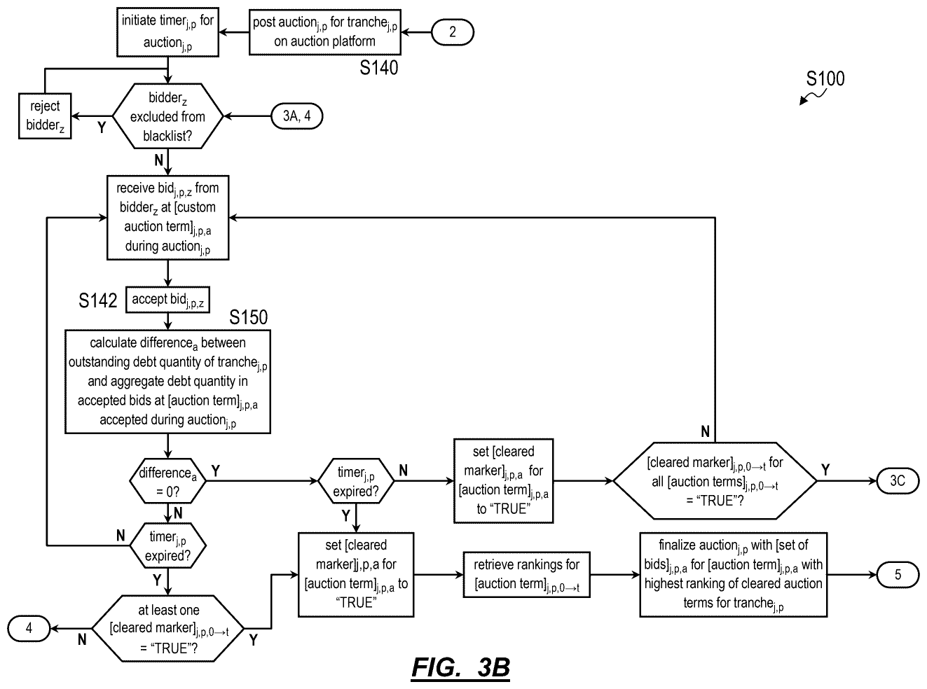

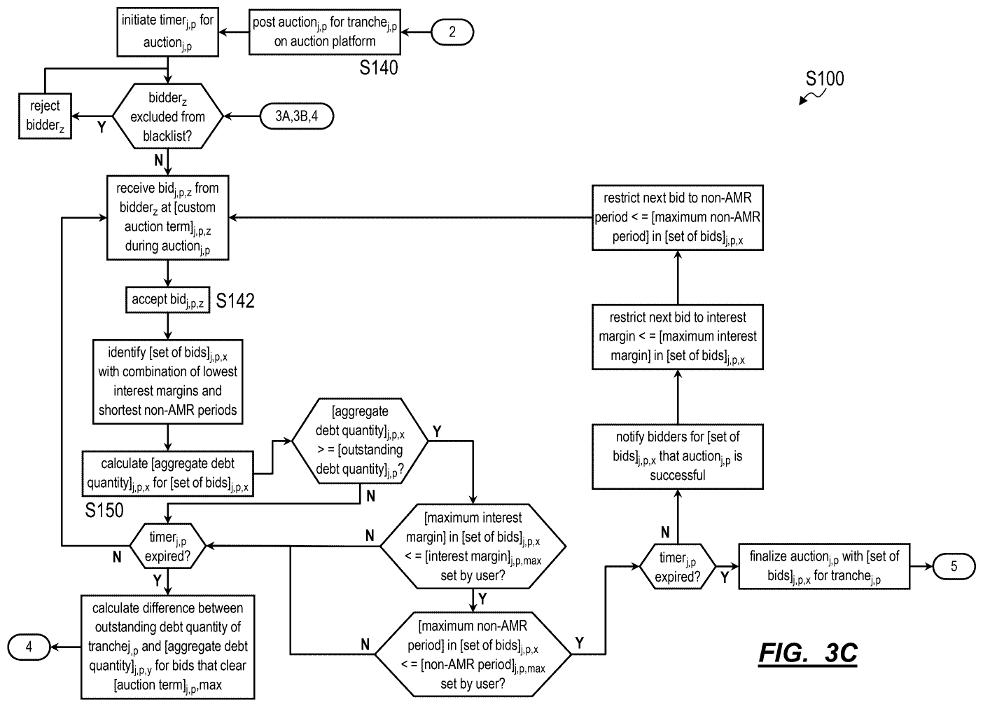

In one variation shown in FIGS. 1 and 3B, the computer system: scans the user's portfolio to identify a set of collateralized loan obligations designating the user as the majority equity holder; identifies a first subset of CLOs—in this set of CLOs—that exclude pending (or “active”) non-call periods; and identifies a first subset of tranches—in the first subset of CLOs—that exclude pending non-AMR periods (described below). For each tranche in this first subset of tranches, the computer system can also: retrieve a current interest margin of the tranche; retrieve a recent interest margin settled for debt in a rating class equal to a rating of the tranche; predict a successful reset interest margin for the tranche (i.e., an interest margin for the tranche that will receive a total quantity of bids within an auction duration sufficient to clear the tranche) and a likelihood of successful interest margin reset based on the recent interest margin; calculate a margin difference between the reset interest margin and the current interest margin of the tranche; and then calculate a score for the tranche based on a combination of an outstanding debt quantity of the tranche and the interest margin difference for the tranche. For example, the computer system can: retrieve published interest margin data for recently-reset CLOs and other debt in the same or similar rating classes; derive a trend from these published interest margin data; and extrapolate a successful reset interest margin for the tranche from this trend based on an average or standard duration of time to initiate and complete debt tranche auctions on the auction platform (e.g., ten days). The computer system can then divide the outstanding debt quantity of the tranche by the interest margin difference to calculate a score for this tranche. The computer system can repeat this process for each other tranche in the first subset of tranches.

The computer system can then: present the first subset of tranches—ordered by score—within the investor portal; and prompt the user to select from this first subset of tranches to initiate an AMR process for a particular tranche. Furthermore, in response to receiving selection of a tranche from this first subset of tranches at the investor portal, the computer system can present a recommendation: for a reset interest margin—thus predicted for the selected tranche—to the user; or for a combination of margin caps and non-AMR periods. In response to confirmation of this recommendation from the user, the computer system can store this reset interest margin as a cap margin for the selected tranche.

In a similar variation, the computer system can execute the foregoing process to calculate a score for each tranche in each CLO for which the user is a majority equity holder. For each of these CLOs, the computer system can sum the scores for all tranches in this CLO and store this value as a composite score for the CLO. The computer system can then present these CLOs—ranked by their composite scores—to the user, and the user can select from this ranked list of CLOs to initiate the AMR process for this CLO.

### 5. Auction Details

Block S112 of the method S100 recites assigning a first cap margin, less than the initial interest margin, to the first tranche. Generally, in Block S112, the computer system can aggregate CLO and debt tranche auction data that informs an election notice and parameters of a debt tranche auction for the selected debt tranche(s).

### 5.1 CLO Data

In one implementation, the computer system retrieves historical data or metrics of the CLO from a database, such as: a history of the CLO (e.g., past changes to debt structure, repayments of debt); remaining outstanding debt quantity in each selected tranche in the CLO; and/or the current interest margin (over LIBOR) for each selected tranche in the CLO.

### 5.2 Interest Margins

The computer system can also prompt the user—via the investor portal—to indicate a cap margin, a maximum interest margin, a minimum interest margin reduction, and/or a set of possible interest margins for each tranche in the CLO thus selected for AMR, as shown in FIG. 1.

In one example, the computer system records a maximum interest margin (e.g., 0.48% over LIBOR) entered manually by the user and assigned this maximum interest margin to the selected tranche. In another example, the computer system: presents an interest margin scale (e.g., from 0.44 to 0.48% over LIBOR in one-basis-point increments) for a selected tranche in the CLO; retrieves a current average interest margin or a range of current interest margins for debt at the same rating as this tranche; indicates this current average or range of interest margins over the interest margin scale; and prompts the user to select a cap margin from this scale at the investor portal. The computer system then assigns a selected cap margin to this particular tranche in the CLO.

In another example, the computer system interfaces with the user to assign a conditional interest margin to the selected tranche. For example, the computer system can: prompt the user to specify a minimum reduction in the interest margin (e.g., two basis points) from the current interest margin that the user believes justifies initiation of the AMR process for the selected tranche; and then calculates a cap margin for this tranche based on this minimum reduction and the current interest margin for this tranche. The computer system can similarly: interface with the user to specify a minimum reduction in the interest margin across all tranches in the CLO thus selected for AMR; and then calculate cap margins for each selected tranche in CLO accordingly.

The computer system can similarly interface with the user to assign different cap margins for various tranches in the CLO thus selected for AMR. For example, the computer system can interface with the user: to assign a maximum interest margin of 0.48% (over LIBOR) for a first tranche (e.g., an AAA tranche) in the CLO; and to assign a maximum interest margin of 0.40% (over LIBOR) for a second tranche (e.g., a BB tranche) in the CLO. In a similar example, the computer system can interface with the user: to specify a minimum reduction in interest margin of four basis points for a first tranche (e.g., an AAA tranche) in the CLO; and to specify a minimum reduction in interest margin of six basis points for a second tranche (e.g., a BB tranche) in the CLO.

However, the computer system can interface with the user in any other way—via the investor portal—to assign a cap margin to each discrete tranche in the CLO.

### 5.3 Non-AMR Period

The computer system can also interface with the user to record a non-AMR period (or a “non-reset period”) for a successful auction of a debt tranche in the CLO. In particular, the computer system can initiate the AMR process for a tranche in the CLO if the non-call period specified in the original CLO indenture has passed; because debt is not redeemed or reissued in the AMR process, a non-call period does not otherwise exist for the CLO and will not otherwise exist following a successful auction such that one or more tranches in the CLO may be re-auctioned soon after (e.g., within days of) close of this AMR process, which may dissuade investors from purchasing debt in the CLO.

Therefore, the user may specify a commitment not to initiate a new auction for a selected debt tranche in the CLO for a period of time after close of the pending AMR process for this tranche (hereinafter a “non-AMR period”) as further incentive for investors to bid on debt in the tranche. For example, if current or predicted market conditions increase preferences for call protection among prospective investors (e.g., the market has recently tightened or is predicted to tighten in the near future), the user may elect to assign a non-AMR period to a particular tranche in the CLO or to the CLO in its entirety. However, if demand for securities is currently high and if the market is currently tight, the user may elect no AMR protection (e.g., a non-AMR period of o months) for this tranche or for the CLO more generally.

Similarly, investors may accept a lower interest margin if this lower interest margin is ensured for a longer period of time. For example, investors may be more apt to bid on higher qualities of debt in a tranche at a lower interest margin with a longer non-AMR period than for debt in the tranche at a higher interest margin with a shorter non-AMR period. In a similar example, a debt tranche with a non-AMR period may trade at a premium over a very similar debt tranche without a non-AMR period. Therefore, the computer system can interface with the user to define a combination of interest margin and non-AMR period that balances investor value and user needs for this tranche.

In one example, the computer system enables the user—via the investor portal—to set a fixed non-AMR period for all tranches in the CLO, such as by selecting or entering a 1-, 3-, 6-, 12-, or 18-month non-AMR period via a set of radio buttons, a dropdown menu, or a text field.

In another example, the computer system enables the user—via the investor portal—to set an individual fixed non-AMR period for each selected tranche in the CLO, such as: a 0-month non-AMR period for a AAA-rated tranche; a 3-month non-AMR period for a AA-rated tranche; a 6-month non-AMR period for a A-rated tranche; and a 9 month non-AMR period for an BBB-rated tranche. In another similar example, the computer system enables the user to define a set of interest margin and fixed non-AMR period pairs for a particular tranche, such as: a 0-month non-AMR period (or “tenure”) for a 0.48% interest margin (or “rate”); a 3-month non-AMR period for a 0.46% interest margin; a 6-month non-AMR period for a 0.44% interest margin; and a 9-month non-AMR period for a 0.42% interest margin.

In yet another example, the computer system can enable the user to set dynamic or “conditional” non-AMR periods for one or more tranches in the CLO, such as a non-AMR period that extends to the earlier of: one year from conclusion of a successful AMR process for a tranche in the CLO; and the market tightening by ten basis points (0.1%). In another example, the user can define: a default non-AMR period of one year for the CLO; a non-AMR period of 6 months after the market tightens by ten basis points (0.1%); and a non-AMR period of 3 months after the market tightens by twenty basis points (0.2%).

In a similar example, the computer system can interface with the user via the investor portal to pair a first cap margin for a selected tranche with a conditional non-reset period for a selected tranche, including: a default non-reset period of a first duration (e.g., 12 months); and an alternate non-reset period of a second duration (e.g., 6 months) less than the first duration responsive to market conditions tightening by a threshold proportion (e.g., ten basis points). Furthermore, if the user elects a multiple-margin auction option for this tranche, the computer system can interface with the user via the investor portal to pair a second cap margin for this tranche with a different non-AMR period, such as a fixed non-reset period of a third duration (e.g., 9 months). Similarly, if the user elects a second tranche in the CLO (or in a different CLO) for concurrent debt tranche auctions on the auction platform, the computer system can interface with the user via the investor portal to assign the same or different non-AMR period to this second tranche.

However, the computer system can enable the user to define any other fixed or dynamic non-AMR period for one or more tranches in the CLO and then record these non-AMR periods accordingly.

Furthermore, in this implementation, the computer system can recommend margins and tenures for a non-AMR period for the CLO based on current market conditions. For example, the computer system can: retrieve current non-AMR or non-call margins and tenures—such as for each tranche in the CLO—from a market watch database; present these margins and tenures to the user via the investor portal; and recommend porting these margins and tenures to tranches in the CLO to the user.

Therefore, the computer system can enable the user to act as her own banker by setting margin and/or tenure parameters for non-AMR periods for the CLO in order to attract investors to the CLO. The computer system can also guide the user toward adjusting these parameters according to current market conditions in order to meet investor expectations and thus increase probability that an auction for a tranche in this CLO closes.

### 5.4 Auction Format

In one variation shown in FIG. 1, the computer system interfaces with the user to specify an auction format for each selected tranche in the CLO.

For example, the computer system can host: single-margin-option auctions in which investors place bids for quantities of debt in a tranche at a single, predefined interest margin confirmed by the majority equity holder prior to auction; multiple-margin-option auctions containing multiple interest margin options—such as paired with different non-AMR periods—and in which investors place bids for quantities of debt in a tranche at any of these interest margins (or at any of these interest margin and non-AMR period combinations) confirmed by the majority equity holder prior to auction; and/or investor-controlled auctions in which investors place bids specifying debt quantities and interest margins (and non-AMR periods) without prior confirmation of interest margin from the user.

In this example, if the user elects a single-margin-option auction for a debt tranche in the CLO, the computer system can implement methods and techniques described above to set a single cap margin (and a single non-AMR period or a conditional non-AMR period) for the corresponding debt tranche auction. However, if the user elects a multiple-margin-option auction for a debt tranche in the CLO, the computer system can implement similar methods and techniques to define multiple (i.e., two or more) interest margin/non-AMR period combinations for the corresponding debt tranche auction. Furthermore, if the user elects an investor-controlled auction for a debt tranche in the CLO, the computer system can interface with the user as described above to set a maximum interest margin (and a maximum non-AMR period) for the corresponding debt tranche auction and then initiate settlement based on results of this auction only if bids specifying interest margins below this maximum interest margin (and specifying non-AMR periods less than the maximum non-AMR period) clear the tranche.

Similarly, if the user elects an investor-controlled auction for a debt tranche in the CLO, the computer system can interface with the user to define multiple maximum interest margin and non-AMR period combinations for the corresponding debt tranche auction, such as: a maximum interest margin of 0.42% for a non-AMR period of twelve months or less; a maximum interest margin of 0.44% for a non-AMR period of eight months or less; a maximum interest margin of 0.46% for a non-AMR period of four months or less; and a maximum interest margin of 0.48% for a non-AMR period of one month or less. The computer system can also prompt the user to rank these interest margin and non-AMR period combinations by preference or otherwise indicate a preference for these interest margin and non-AMR period combinations. Then, upon completion of the auction, the computer system can identify a group of auction bids that both: clear the tranche; and specify minimum interest margin and minimum non-AMR period that fulfill at least one interest margin and non-AMR period combination specified by the user. However, if the computer system identifies multiple groups of bids, each of which clears the tranche and fulfills at least one interest margin and non-AMR period combination specified by the user, the computer system can: select a particular group of bids that fulfill the highest-ranked interest margin and non-AMR period combination specified by the user; and then initiate settlement for this tranche according to this particular group of bids, such as described below.

### 5.5 Broker-Dealer Whitelist/Blacklist

As shown in FIG. 1, the computer system can also interface with the user to add broker-dealers to a whitelist and/or blacklist for the upcoming AMR of the CLO generally or for AMRs of particular tranches within the CLO.

For example, the computer system can serve—via the investor portal—a list of all broker-dealers on the auction platform, such as sorted: by tranche rating, bid size, and/or bid frequency of past CLO AMR auction bids on the auction platform; and/or by whether the broker-dealer previously bid on debt in an AMR initiated by the user specifically. The user may then select broker-dealers from this list to add to a blacklist in order to limit participation (e.g., bid submission) of these broker-dealers: in an auction for debt in any CLO selected for AMR by the user; in an auction for debt in a particular CLO; and/or in an auction for debt in particular tranche in a particular CLO.

In a similar example, the computer system can: retrieve a set of maximum historical bid amounts settled by investors (e.g., broker-dealers and/or individual investors) in a population of investors; populate a whitelist for the online public auction with a first identifier of a first investor—in the population of investors—if this investor has not previously failed to settle a bid on the auction platform; calculate a first bid limit for the first investor based on a function of (e.g., 1.3×) a maximum bid amount submitted and settled by the investor for a second online public auction previously hosted on the auction platform; and assign the first bid limit to the first identifier of the first investor in the whitelist. Later, during the auction for debt in this tranche, the computer system can limit bids submitted by the first investor to this first bid limit.

Additionally or alternatively, the computer system can record bid limits entered manually for these investors, such as for the CLO generally or for specific tranches in the CLO; and the computer system can record these bid limits to identifiers of these investors in the whitelist.

### 5.6 AMR Configuration File

The computer system can then aggregate the foregoing tranche selection, interest margin, non-AMR period, auction time, whitelist, and/or blacklist data, etc. into an AMR configuration file for this CLO (or for the particular tranches in the CLO selected by the user).

### 6. Margin Research

In one variation, the computer system automatically collects interest margin feedback from broker-dealers and compiles this feedback into a recommendation for a cap margin for a tranche.

In one implementation, once the user selects a tranche in a CLO as described above, the computer system: generates a query for interest margin preferences for the selected tranche; transmits this query such as in the form of an electronic notification or email—to a group of broker-dealers on the auction platform; and collects responses from these broker-dealers, such as submitted over a limited period of time (e.g., one day). The computer system can then: filter outliers from these responses; derive a target range of interest margins—less than the current interest margin of the tranche—from these responses; prompt the majority equity holder to select from this target range of interest margins; and then assign a cap margin—selected from the target range of interest margins by the majority equity holder—to the tranche.

Additionally or alternatively, the computer system can automatically poll broker-dealers for interest margin preferences for a tranche once a non-call period and/or a non-AMR period for this tranche has expired—and before the user selects this tranche for AMR. The computer system can then: calculate an average (or median) of interest margin responses from these broker-dealers; and score this tranche based on this average interest margin, such as by dividing the outstanding debt quantity of the tranche by a difference between the average interest margin and the current interest margin of the tranche. The computer system can then recommend selection of the tranche for AMR if this score exceeds a threshold score. The computer system can also: repeat this process for other tranches and CLOs in the user's portfolio; and sort these tranches for AMR in the investor portal according to their scores, as described above.

### 7. Election Notice

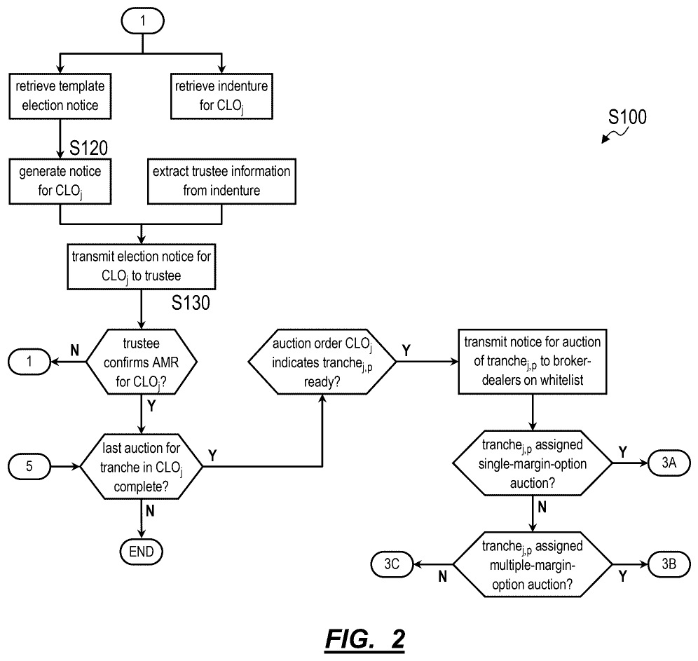

Block S120 of the method S100 recites generating an election notice for applicable margin reset for the tranche based on a template election notice. Generally, in Block S120, the computer system can populate a template election notice with CLO data, interest margin and tranche parameters, non-AMR periods, and global and/or user-specified whitelist or blacklist data collected in Block S110 in order to generate a new election notice for AMR of the CLO, as shown in FIG. 2.

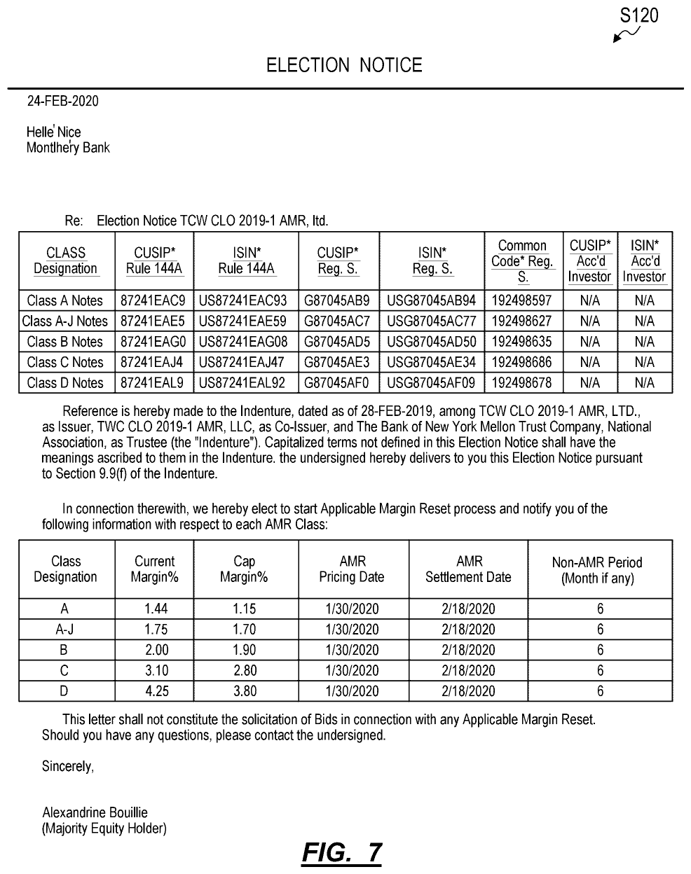

In one implementation, the computer system retrieves a standard (or “pre-approved”) template election notice form that contains a set of data fields, each including a pointer to a location and to a type of data structure contained in the CLO indenture and in the AMR configuration file. The computer system then automatically ports data in these locations and of these types from the CLO indenture and the AMR configuration file into corresponding fields in the standard election notice form to generate a new election notice for the CLO thus elected for AMR by the user, as shown in FIG. 7.

In one variation, the computer system further presents the new election notice to the user (or serves this new election notice to the user's legal counsel or other relevant party, such as in electronic format) for further modification and finalization before distributing the election notice to the CLO's trustee.

### 8. Election Notice Validation and Distribution

Block S130 of the method S100 recites serving the election notice to a trustee associated with the CLO for distribution to debt holders holding debt in the CLO. Generally, once the computer system generates the election notice in Block S120, the computer system can: retrieve contact information (e.g., an email address, an internal messaging address on the auction platform) for a trustee of the CLO, such as identified in the CLO's indenture; and then automatically transmit the election notice to the trustee in Block S130, as shown in FIG. 2.

The trustee may then: confirm that the election notice is valid, such as by confirming that all non-call periods for the CLO have expired; and then inform all other debt holders in the CLO of the election notice, such as identified in holding records for debt in the CLO stored by the external trust and securities clearing service. For example, the trustee may send the election notice (or relevant information contained therein) to these current debt holders, thereby informing these debt holders of: the user's intent to refinance one or more tranches in the CLO via the AMR process.

### 9. Single-Tranche Auction

Block S140 of the method S100 recites initiating an online public auction for debt in the tranche on an auction platform in response to confirmation of the election notice by the trustee; and Block S142 of the method S100 recites, during the online public auction, recording a set of bids submitted by a set of broker-dealers on the auction platform in Block S142, wherein each bid in the set of bids specifies a debt quantity in the tranche at a new interest margin less than the current interest margin of the tranche. In particular, the computer system can host an auction for the CLO—or one auction per listed tranche in the CLO—on the auction platform in Block S140 once the trustee confirms refinancing of the CLO and then record bids from broker-dealers for debt in the CLO during the auction in Block S142, as shown in FIGS. 3A and 5.

### 9.1 Auction Initiation

In one implementation, the computer system initiates one unique auction for each tranche in the CLO for a period of time (e.g., two days) following receipt of verification from the trustee (e.g., within ten days from initiation of the AMR process for the CLO by the user).

### 9.2 Single-Margin-Option Auction

In one implementation in which the user selects a single-margin-option auction for the tranche, as shown in FIG. 3A, the computer system can interface with the user as described above to define a single cap margin—paired with a fixed or conditional non-AMR period—for an auction for this tranche on the auction platform. During this auction, the computer system can record bids—entered by broker-dealers (or by individual investors) for quantities of debt at this predefined cap margin.

During this auction, in response to receiving a new bid from a broker-dealer (or individual investor), the computer system can: calculate a sum of debt quantities specified in this new bid and all preceding bids submitted during this auction; calculate a difference between this sum and the outstanding debt quantity of the tranche; and then limit a debt quantity of a next bid submitted during the online public auction to the difference, thereby limiting the aggregate debt quantity across bids submitted during this auction to the outstanding debt quantity of the tranche.

Furthermore, in this implementation, the computer system can set a timer at the start of the auction, such as for an auction duration of five days. The computer system can then close the auction at the earlier of: expiration of the timer; and the sum of all bids entered in the auction equaling the outstanding debt quantity of the tranche.

### 9.3 Multiple-Margin-Option Auction

In another variation in which the user selects a multiple-margin-option auction for the tranche, as shown in FIGS. 3B and 6, the computer system can interface with the user as described above to define multiple cap margin and non-AMR period pairs (or “auction terms”) for an auction for this tranche on the auction platform. During this auction, the computer system can record multiple groups of bids entered by broker-dealers (or by individual investors), wherein each group of bids corresponds to one cap margin and non-AMR period pair.

For example, during this auction, the computer system can: record a first set of bids submitted by a first set of investors via the auction platform in Block S142, wherein each bid in this first set specifies a debt quantity according to a first auction term; concurrently record a second set of bids submitted by a second set of investors via the auction platform in Block S142, wherein each bid in this second set specifies a debt quantity according to second auction terms; track a first sum of debt quantities specified in the first set of bids; and similarly track a second sum of debt quantities specified in the second set of bids throughout the auction. Upon conclusion of the auction, if the first sum clears the outstanding debt quantity of the tranche but if the second sum falls below this outstanding debt quantity, the computer system can initiate settlement and redistribution of the outstanding debt quantity in the tranche to the first set of investors according to the first set of bids and the first auction term (i.e., a first cap margin and a first non-AMR period).

Alternatively, if both the first and second sums clear the outstanding debt quantity of the tranche upon conclusion of the action, the computer system can: retrieve a preloaded auction term preference set by the user prior to the auction; and initiate settlement according to the preferred auction term. Yet alternatively, the computer system can: transmit a prompt to the user to select one of the two corresponding auction terms to complete the AMR process; and then initiate settlement according to the user's selection.

Therefore, in this implementation, the computer system can manage a multiple-margin-option auction containing multiple interest margin options—such as paired with different non-AMR periods—by recording bids for quantities of debt across multiple preloaded interest margin and non-AMR period pairs.

In one example, a broker-dealer may enter bids for different debt quantities for different preloaded auction terms—predefined by the user and/or specified by the broker-dealer—within a particular tranche in the CLO, such as: $10M in debt quantity at 0.46% over LIBOR; $9M in debt quantity at 0.44% over LIBOR; and $5M in debt quantity at 0.42% over LIBOR. In this example, the computer system can also require a participating broker-dealer to enter a bid for a debt quantity at each preloaded auction term in this auction or enable the broker-dealer to enter a bid for one or a subset of these preloaded auction terms.

Furthermore, in this implementation, the computer system can set a timer at the start of the auction, such as for an auction duration of five days. The computer system can then close each preloaded interest margin and non-AMR period combination in the auction at the earlier of: expiration of the timer; and the sum of all bids entered for this preloaded interest margin and non-AMR period combination equaling (or exceeding) the outstanding debt quantity of the tranche.

### 9.4 Investor-Controlled Auction

In another variation in which the user selects an investor-controlled auction for the tranche, as shown in FIGS. 3C ad 6, the computer system can interface with the user as described above to define: a maximum interest margin; a maximum non-AMR period; and/or a function that links maximum interest margin to maximum non-AMR period. During this auction, the computer system can record a set of bids submitted by a set of investors, wherein each bid in this set specifies a combination of debt quantity, interest margin, and non-AMR period customized by an investor.

In one implementation, the computer system obscures interest margin and non-AMR period combinations specified in bids posted by investors. Alternatively, the computer system can: calculate an average interest margin and an average non-AMR period across these bids, interest margin and non-AMR period trends across these bids, and/or an average of trending relationships between interest margin and non-AMR period across these bids, etc.; and then present these data within the auction. The computer system computer network can also prompt investors viewing the auction to place bids at one of the interest margin and non-AMR period combinations specified in a previous bid entered during this auction.

Throughout the auction, the computer system can also scan bids entered during the auction for a subset of bids: that specify debt quantities that skew toward lower interest margins across this set of bids; that sum to an aggregate debt quantity that clears the outstanding debt quantity of the tranche; that specify interest margins less than the maximum interest margin set by the user; that specify non-AMR periods less than the maximum non-AMR period set by the user (or less than a maximum non-AMR period for the maximum interest margin specified in this set of bids). In response to successfully identifying this set of bids, the computer system can notify investors who placed bids that the auction will successfully close at the maximum interest margin and at the maximum non-AMR period specified in this subset of bids. In response to successfully identifying this set of bids, the computer system can also disable entry of further bids: that specify higher interest margins; that specify longer non-AMR periods; and/or that specify combinations of interest margins and non-AMR periods indicated as less desirable—by the user—than the successful interest margin and non-AMR period combination. However, the computer system can: maintain the auction; continue to record bids at lower interest margins and/or shorter non-AMR periods; rescan submitted bids for subsets of bids that clear the outstanding debt quantity of the tranche, specify lower maximum interest margins, and specify shorter non-AMR periods; and repeat the foregoing process accordingly, such as responsive to entry of each subsequent bid during the auction.

In one variation, when a broker-dealer enters a bid for debt of a particular quantity at a particular interest margin and/or non-AMR period within the debt tranche auction, the computer system can estimate or calculate a comparable bid at another debt quantity, interest margin, and/or non-AMR period for debt in this tranche, such as based on current market conditions, a predefined bid model, or historical bids entered by broker-dealers during past auctions on the auction platform. For example, after receiving a bid specifying a particular interest margin and a particular non-AMR period, the computer system can recommend that this investor place a second bid at a lower interest margin and longer non-AMR period based on a trending relationship between these values across successful auctions recently completed on the auction platform.

### 9.5 Hybrid Auction

In another variation shown in FIGS. 3B and 3C, the computer system executes the foregoing methods and techniques to host a single- or multiple-margin-option auction for the tranche. However, when bids for one (or multiple, all) interest margin and non-AMR period combination entered during this auction clear the total debt amount of the tranche, the computer system transitions to enabling investors to enter custom debt quantity, interest margin, and non-AMR period combinations according to investor-controlled auction processes described above.

For example, the computer system can: set a timer for an auction duration in response to initiating the online public auction; record bids—specifying a first preloaded interest margin and non-AMR period combination—throughout this auction; and implement methods and techniques described above to identify a set of bids that clear the outstanding debt quantity of the tranche prior to expiration of the timer. Then, in response to identifying this set of bids, the computer system can: transmit an electronic notification indicating clearance of the outstanding debt quantity of the tranche at the first preloaded interest margin and non-AMR period combination to investors who placed bids during this auction; and enable submission of bids—for debt in the first tranche—specifying investor-defined debt quantity, interest margin, and non-AMR period combinations, such as limited to lower interest margins and/or short non-AMR periods. Alternatively, in response to identifying a set of bids that clear the tranche at the first preloaded interest margin and non-AMR period combination, the computer system can, activate a second preloaded interest margin and non-AMR period combination and record bids at this second preloaded interest margin and non-AMR period combination until the earlier of: receipt of a second set of bids that clear the tranche at this second preloaded interest margin and non-AMR period combination; and expiration of the auction timer.

In another implementation, the computer system can enable an investor to place a second bid with a custom debt quantity, interest margin, and non-AMR period combination following receipt of a bid at a preloaded interest margin and non-AMR period combination during this auction. For example, submission of a first bid at a preloaded interest margin and non-AMR period combination may indicate that the investor is committed to acquiring debt in the tranche. However, the investor may be willing to purchase a higher quantity of debt in this tranche, accept a lower interest margin, and/or accept a short non-AMR period. Therefore, once the investor has submitted a bid and this indicated intent to purchase debt in the tranche, the computer system can also enable the broker-dealer to place an additional bid at a custom, investor-specified interest margin and non-AMR period combination. The computer system can then: hide these investor-specified interest margin and non-AMR period combinations from other broker-dealers viewing this auction; expose these investor-specified interest margin and non-AMR period combinations to another investor only after once this other investor submits a bid in this auction; or publish this bid characteristics automatically and by default.

### 9.6 Transparency

Furthermore, through an auction for a tranche in the CLO, the computer system can hide individual bid quantities and a total bid quantity for the tranche from broker-dealers. Alternatively, the computer system can calculate bid metrics for the auction to broker-dealers. For example, for each predefined interest margin in a particular tranche in the CLO, the computer system can calculate total (i.e., sum) bid quantity, a remaining bid quantity needed to clear the tranche, an average bid quantity, and/or a bid quantity variance or standard deviation for the particular interest margin in the particular tranche. The computer system can then present these metrics within an auction page for the tranche on the auction platform, thereby enabling prospective participants in the auction to monitor both likelihood of successful refinancing of the tranche and market demand for debt in the tranche.

The computer system can implement the foregoing methods and techniques to host one auction for each user-elected tranche in the CLO or host one auction generally for the CLO. However, the computer system can implement any other method or technique to host an auction for debt in the CLO.

### 9.7 Selective Release of Auction Details

Generally, the computer system can publish color for the auction to bidders and the market more generally during the auction according to color rules assigned to the security (e.g., by releasing color once a condition is met).

In one implementation, in response to aggregating a set of electronic bids falling below the remaining debt of a particular tranche, the computer system can release color to specific entities, such as bidders, action viewers, or the market more generally. In particular, in this implementation, the computer system can: receive selection of a first tranche, in a set of tranches associated with an initial interest margin at the first time, and containing a first outstanding debt quantity; assign a first cap margin, less than the initial interest margin, to the first tranche; and initiate an online public auction, for the first outstanding debt quantity in the first tranche, on an auction platform.

The computer system can then, during the online public auction: record a first set of electronic bids submitted by a first set of investors via the set of electronic bidding portals, each electronic bid in the first set of electronic bids specifying a debt quantity at the first cap margin; calculate a first sum of debt quantities, at the first cap margin, specified in the first set of electronic bids; and, in response to the first sum of debt quantities falling below the first outstanding debt quantity, selectively publish color to a subset of investors in the first set of investors.

For example, the computer system can transmit an electronic notification indicating the first sum of debt quantities falling below the first outstanding debt quantity of the first tranche to a subset of investors, in the first set of investors, including: all viewers; all bidders; all bidders with bids over a threshold price; and/or bidders with top one, three, or five bid prices, order sizes, or combination of bid prices and order sizes.

In one example, the computer system can: receive selection of an AAA-rated tranche associated with a current interest margin of 0.5% (over LIBOR) at the first time and containing an outstanding debt quantity of $10M (i.e., $10M in unpaid, outstanding debt); assign a cap margin of 0.45% (over LIBOR) to the first tranche; and initiate the online public auction on the auction platform.

The computer system can then, during the online public auction: record a set of 100 electronic bids submitted by a set of investors via the set of electronic bidding portals, each electronic bid in the set of 100 electronic bids specifying a debt quantity at the cap margin of 0.45% (over LIBOR); calculate a first sum of debt quantities totaling $9M at the cap margin of 0.45% (over LIBOR); and, in response to the first sum of $9M falling below the outstanding debt quantity of $10M, publish the first sum of debt quantities totaling $9M to a subset of five investors, in the set of investors, with the top five order sizes. Therefore, the computer system can selectively disclose aggregated bid data to targeted investors or market participants as the total bid amount approaches the required debt quantity to stimulate additional interest and drive competitive bidding activity, thereby increasing probability that an auction for a tranche in this CLO closes.

### 9.8 Automatic Final Bid Adjustments

In one variation, the computer system can automatically adjust the debt quantities of submitted bids based on a minimum bid quantity required to bid on a particular tranche. In particular, in this variation, the computer system can: record a first electronic bid submitted by a first investor via a first electronic bidding portal, the first electronic bid specifying a first preliminary debt quantity of at the first cap margin; calculate a sum of remaining debt quantities based on the first electronic bid; and, in response to the sum of remaining debt quantities falling below a minimum bid quantity defined for the first tranche, automatically reduce the first preliminary debt quantity to a first final debt quantity, wherein the difference between the sum of remaining debt quantities and the first final debt quantity is greater than the minimum bid quantity.

In one example, the computer system can: receive selection of an AA tranche associated with a current interest margin of 0.35% (over LIBOR) at the first time and containing an outstanding debt quantity of $1.25M (i.e., $1.25M in unpaid, outstanding debt); assign a cap margin of 0.30% (over LIBOR) to the first tranche; define a minimum bid quantity of $500K for each bid submitted on the AAA-rated tranche; and initiate the online public auction on the auction platform.

The computer system can then, during the online public auction: record first electronic bid submitted by a first investor via a first electronic bidding portal and specifying a preliminary debt quantity of $1M at the cap margin of 0.30% (over LIBOR); and calculate a first sum of remaining debt quantities totaling $250K based on the first electronic bid.

The computer system can then automatically reduce the preliminary debt quantity of $1M of the first electronic bid to a final debt quantity of $750K in response to the first sum of remaining debt quantities of $250K falling below the minimum bid quantity of $500K. Thus, the computer system adjust the final debt quantity of the first bidder to enable a second, subsequent bidder to submit a valid bid that meets the minimum bid quantity of $500K. Therefore, the computer system can automatically: adjust debt quantities of submitted bids; and electronically notify investors in near real-time of the sum of remaining debt quantities, thereby preventing auction failures resulting from invalid bid submissions below the minimum bid quantity.

### 9.9 Blackout Periods

In one variation, the computer system can selectively disable bidding portals for bidding on a particular tranche based on a blackout period defined for each bid submitted on the tranche. In this variation, in response to receiving an electronic bid from an investor at a new margin above a cap margin defined for the tranche, the computer system can: discard the electronic bid; and initiate a blackout period based on a duration defined for the tranche. In particular, the computer system can: automatically disable an electronic bidding portal associated with the investor for the blackout duration upon discarding the electronic bid; and automatically re-enable the electronic bidding portal upon expiration of the blackout period.

In one example, the computer system can: receive selection of a B-rated tranche associated with a current interest margin of 0.40% (over LIBOR) at the first time and containing an outstanding debt quantity of $1B (i.e., $1B in unpaid, outstanding debt); assign a cap margin of 0.35% (over LIBOR) to the first tranche; access a blackout period of one week defined for each bid submitted by a particular investor on the B-rated tranche; and initiate the online public auction on the auction platform.

The computer system can then, during the online public auction, record a first electronic bid submitted by a first investor and specifying a debt quantity of $20M at a new margin of 0.37% (above the cap margin of 0.30%). In response to receiving the first electronic bid at the new margin above the cap margin, the computer system can: discard the first electronic bid; and disable the first electronic bidding portal for one week according to the one week blackout period defined for the B-rated tranche. Upon expiration of the blackout period, the computer system can reopen the first electronic bidding portal.

Therefore, the computer system can prevent an investor from continuously submitting bids after each rejection in an attempt to achieve the lowest acceptable margin, thereby maintaining the integrity of the bidding process and preventing manipulation of the auction's cap margin thresholds.

### 9.10 Electronic Ledger

In one implementation, the computer system can: aggregate a corpus of bid metadata into a public electronic ledger representing historical bidding metadata; and publish the public electronic ledger (e.g., for access by investors). For example, for each electronic bid in a set of electronic bids recorded for an auction of a first tranche, the computer system can record: a timestamp associated with submission of the electronic bid; a numerical investor identifier associated with the investor submitting the bid; the debt quantity; and the particular cap margin.

Thus, for the first tranche, the computer system can: aggregate a corpus of bid metadata identifying the CLO, the first tranche, the debt quantities, and the particular cap margins; encrypt the corpus of bid metadata; initiate generation of a block containing the corpus of bid metadata on a blockchain for storage on a public electronic ledger; and publish the public electronic ledger. Therefore, the computer system can: obfuscate user identifiers to preserve investor anonymity while generating a comprehensive, tamper-proof public auditable ledger.

In one variation, rather than publishing the electronic ledger, the computer system can: encrypt metadata associated with a particular tranche; and selectively assign a private decryption key to an investor for decrypting the metadata in response to recording an electronic bid at or below the cap margin.

In one example, the computer system can: receive selection of an AA-rated tranche assigned a cap margin of 0.30% (over LIBOR) to the AA-rated tranche; encrypt an electronic ledger including a set of metadata associated with the AA-rated tranche via a private encryption key; define a minimum bid quantity of $1M to access the electronic ledger; and initiate the online public auction on the auction platform.

The computer system can then, during the online public auction: record first electronic bid submitted by a first investor via a first electronic bidding portal, the first electronic bid specifying a debt quantity of $2M at the cap margin of 0.30% (over LIBOR); and transmit a private decryption key to the first investor for decrypting the set of metadata associated with the AA-rated tranche in response to recording the first electronic bid specifying the debt quantity of $2M at the cap margin of 0.30% (over LIBOR). Therefore, the computer system can selectively disclose aggregated bid data to targeted investors or market participants to stimulate additional interest and drive competitive bidding activity, thereby increasing probability that an auction for a tranche in this CLO closes.

### 10. User-Driven Auction Changes

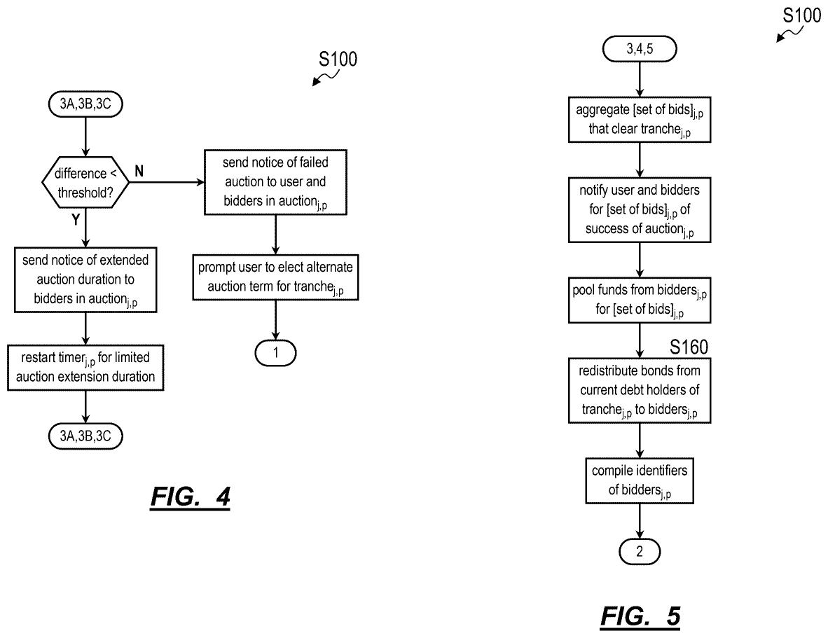

In one variation shown in FIG. 4, the computer system also enables the user to modify the AMR process for the CLO, such as one time during the auction. For example, the computer system can enable the user—via the investor portal—to: change an interest margin, modify a non-AMR period, or modify a whitelist or blacklist for one or more listed tranches in the CLO; or add or remove a tranche in the CLO from the AMR process during the auction.

In this variation, when the user elects to modify the AMR process for the CLO, the computer system can: pause the auction; notify broker-dealers of the auction pause; update the election notice with modified quantities entered by the user; resend the revised election notice to the trustee for verification and distribution to current debt holders; and then reinitiate the auction according to these modified quantities once confirmed by the trustee. The computer system can also: automatically cancel bids affected by the modified quantities entered by the user; or prompt these broker-dealers to modify or confirm existing bids affected by these modified quantities.

### 11. Auction Cancellation

Similarly, the computer system can enable the user to cancel the auction prior to its conclusion, such as to reduce or avoid auction fees if the market widens and probability of auction success drops over the course of the auction.

In this variation, the computer system can: track marketed securities during an auction for a tranche in the CLO, such as other auctions on the auction platform or securities sold on other secondary markets; predict a result of the auction for the tranche based on prices and ratings of these other securities and characteristics of the auction; and then serve a recommendation to the user—via the investor portal—to maintain or cancel the auction for the tranche (or auctions for all tranches in the CLO more generally) based on whether the computer system predicts success of the tranche auction.

### 11.1 Failure Prediction

In one variation shown in FIGS. 3A and 4, the computer system can calculate a probability that bids submitted during the auction will clear the outstanding debt quantity, interest margin requirements, and non-AMR period requirements of the tranche and then selectively prompt the user to cancel the auction or amend terms of the auction in order to increase probability of success prior to end of the auction.

For example, during the auction, the computer system can monitor a rate of bid submission and predict failure of the auction if this rate of bid submission falls below a threshold rate. In a similar example, the computer system can: calculate a trend in bid debt volume as a function of frequency of submitted bids and debt quantities specified in these bids; extrapolate this trend in bid debt volume to the expiration time of the auction based on an auction model that reflects typical high bid frequencies at beginnings and ends of auctions; and predicts failure of the auction if the extrapolated bid debt volume falls below the outstanding debt quantity in the tranche at the expiration time of the auction.

Then, in response to predicting failure of the online public auction, the computer system can prompt the user to cancel the auction or increase the interest margin and/or the non-AMR period for the tranche. Additionally or alternatively, the computer system can: implement methods and techniques described above to calculate a revised cap margin—between the current interest margin of the tranche and the cap margin initially assigned to the tranche—that is predicted to achieve bids sufficient to clear the tranche; and prompt the user to revise the auction according to this revised cap margin. The computer system can similarly: implement methods and techniques described above to calculate a revised non-AMR period—longer than the non-AMR period initially assigned to the tranche—that is predicted to achieve bids sufficient to clear the tranche; and prompt the user to revise the auction according to this revised non-AMR period.

However, the computer system can implement any other method or technique to predict failure of the auction and to guide the user toward revising terms of the auction in order to increase probability of success.

### 12. Auction Results

Block S150 of the method S100 recites calculating a sum of debt quantities at the new interest margin submitted by the set of broker-dealers during the online public auction. Generally, upon conclusion of an auction for a tranche in the CLO, the computer system can aggregate bid quantities for debt in the tranche at each user-specified or broker-dealer-specified interest rate (or non-AMR period, etc.) in the tranche and verifies whether conditions necessary to clear the tranche have been met in Block S150.

### 12.1 Auction Results: Single-Margin-Option Auction

For a single-margin-option auction, the computer system verify that bids submitted during this auction clear the debt quantity of the tranche upon or before conclusion of the auction, as shown in FIGS. 3A and 5.

In one example, a tranche (e.g., an AA-rated tranche) in the CLO has an outstanding debt quantity of $10M (i.e., $10M in unpaid, outstanding debt). The current interest margin for this tranche is 0.5% (over LIBOR). In Block S150, the computer system aggregates bids entered by broker-dealers during the auction to confirm that a total bid quantity—at an interest margin (or a “clearing margin”) less than the current interest margin for the tranche—meets or exceeds the outstanding debt quantity (i.e., $10M). If so, the computer system can initiate settlement of the debt in this tranche in Block S162.

Otherwise, the computer system can cancel the auction. The computer system can also interface with the user to revise auction terms for this tranche and relist this tranche on the auction platform accordingly.

### 12.2 Auction Results: Multiple-Margin-Option Auction

Alternatively, for a multiple-margin option auction, broker-dealers (or investors more generally) may have entered bids across a set of preloaded auction terms (i.e., interest margin and non-AMR period combinations) during this auction. The computer system can therefore implement the foregoing process to verify whether bids at each auction term clear the outstanding debt quantity of the tranche. If a single action term in this auction cleared, the computer system can then initiate settlement according to bids placed at this auction term. Similarly, if multiple action terms in this auction cleared, the computer system can then initiate settlement: according to bids that clear the outstanding debt quantity of the tranche and that specify a lowest interest margin; according to bids that clear the outstanding debt quantity of the tranche and that specify a preferred auction term previously selected by the user; or according to bids that clear the outstanding debt quantity of the tranche and that the user manually elected following conclusion of the auction, as shown in FIGS. 3B and 5.

For example, during an auction for a tranche (e.g., an AA-rated tranche) with an outstanding debt quantity of $10M, broker-dealers may have entered: a first set of bids totaling a debt quantity of $13M at an interest margin of 0.48% (over LIBOR); a second set of bids totaling a debt quantity of $8.5M at an interest margin of 0.3% (over LIBOR); and a third set of bids totaling a debt quantity of $10.2M at an interest margin of 0.4% (over LIBOR). Accordingly, the computer system can reject the first and second sets of bids but accept the third set of bids, which meet total quantity and interest margin requirements of the auction.

In another example, the computer system can prompt the user to rank auction terms for this auction or otherwise indicate auction term preferences prior to the auction. During the auction, the computer system can disable a particular auction term in this multiple-margin-option auction once the aggregate debt quantity of a set of bids at this particular auction term meets the outstanding debt quantity of the tranche. If the particular auction term of this set of bids corresponds to the user's preferred auction term, the computer system can also close the auction once the aggregate debt quantity of this set of bids at this particular auction term meets the outstanding debt quantity of the tranche. Alternatively, the computer system can continue to host the auction over the remainder of the auction and then initiate settlement for a set of bids—at a highest-ranked auction term—that clear the outstanding debt quantity of the tranche.

Alternatively, the computer system can enable broker-dealers to submit bids—at a particular preloaded interest margin—that sum to debt quantities in excess of the outstanding debt quantity of the tranche. The computer system can then: aggregate bids specifying the largest debt quantities at a particular interest margin and summing to the outstanding debt quantity; and discard any remaining smaller bids. Yet, alternatively, the computer system can proportion scale debt quantities specified in bids at a particular interest margin such that these bids sum to the outstanding debt quantity in the tranche. Alternatively, the computer system can aggregate bids at a particular interest margin (or a “clearing margin”) up to the outstanding debt quantity of the tranche in order of bid submission and discard any subsequent bids, thereby rewarding earlier bidders by fulfilling more or all of their entered bid quantities at this interest margin.

In another implementation, if the tranche is not cleared by a pool of bids at a lowest interest margin, the computer system can sum bid quantities at the lowest and second-lowest interest margins. If the sum of all bid quantity at the lowest- and second-lowest interest margin clears the tranche and if the second-lowest interest margin is less than or equal to the maximum interest margin specified by the user, the computer system can initiate settlement of the tranche with these broker-dealers at the second-lowest interest margin in Block S160. (The computer system can also: transmit notifications to these broker-dealers to inform these broker-dealers of higher available interest margin at their original bid quantities and prompt these broker-dealers to confirm these updates to their bids; and compile these bids at the first interest margin with bids at the second interest margin once these broker-dealers confirm updates to their bids.) Broker-dealers who placed bids at the lowest interest margin may therefore receive the second-lowest interest margin. However, if the aggregate debt quantity at the second-lowest interest margin and below does not clear the tranche, the computer system can sum bid quantities at the first, the second, and a third-lowest interest margin; if the aggregate debt quantity at the third-lowest interest margin and below clears the tranche and if the third-lowest interest margin is less than or equal to the maximum interest margin specified by the user, the computer system can initiate settlement of the tranche with these broker-dealers at the third-lowest interest margin in Block S160. Alternatively, the computer system can repeat this process for higher interest margins up to a maximum interest margin indicated by the user or until the tranche is cleared.

In another example, if the aggregate debt quantity of bids submitted by broker-dealers at a particular (low) interest margin for the tranche is less than but near (e.g., within 10% of) the outstanding debt quantity of the tranche, the computer system can automatically message broker-dealers who bid on the tranche at higher interest margins with: a notice of remaining availability of debt in the tranche at the particular interest margin; an option to revise their bids down to the particular interest margin or to submit new bids for unclaimed debt at the lower interest margin in the tranche; and a time limit for post-auction bids in the tranche. (In this example, the computer system can implement similar methods and techniques to collects bids for remaining debt at a particular interest margin if the aggregate debt quantity bid at the particular interest margin for the tranche is less than but near (e.g., within 2% of) the outstanding debt quantity of the tranche even if the tranche was cleared at a higher interest margin.)

However, the computer system can implement any other method or technique to collect bids from broker-dealers and to verify whether aggregate bids submitted by broker-dealers during an auction for a tranche in the CLO clear the tranche in Block S150. The computer system can also implement these methods and techniques for each listed tranche in the CLO or for the CLO more generally.

Furthermore, upon completion of auctions for tranches in the CLO, the computer system can publish auction results to the auction platform, such as outstanding debt quantity bid, total quantity of bids, and auction status for various interest margins in each listed tranche in the CLO.

### 12.3 Auction Results: Investor-Controlled Auction

Alternatively, for an investor-controlled auction, broker-dealers (or investors more generally) may have entered bids across a range of interest margin and non-AMR period combinations. The computer system can therefore scan bids entered by these broker-dealers during this auction for a subset of bids that: sum to a debt quantity that clears (i.e., is greater than or equal to) the outstanding debt quantity of the tranche; that specify a combination of interest margins that skew toward a lower end of the range of submitted interest margins or that fall below a maximum interest margin specified by the user for this auction; and that specify a combination of naps that skew today a lower end of the range of submitted naps or that fall below a maximum non-AMR period specified by the user for this auction, shown in FIGS. 3C, 5, and 6.

More specifically, a bid entered by a broker-dealer during this investor-controlled auction may specify a minimum interest margin and a minimum non-AMR period that this broker-dealer may accept for a particular debt quantity. Therefore, the computer system can scan bids entered by broker-dealers during this auction to identify a subset of bids that specify debt quantities that meet or exceed the outstanding debt quantity of the tranche while also: fulfilling the minimum interest margins and the minimum non-AMR periods specified in these bids; and fulfilling a maximum interest margin and a maximum non-AMR period set for the debt tranche auction.

Then, in response to identifying such a subset of bids upon conclusion of the auction, the computer system can: assign the highest interest margin (or a “clearing margin”) in this subset of bids to the final auction result, as shown in FIG. 6; assign the longest non-AMR period in this subset of bids to the final auction result; inform broker-dealers who placed these bids of these final auction terms; and initiate settlement according to debt quantities specified in this subset of bids and according to these final auction terms.

Similarly, in response to identifying such a subset of bids prior to conclusion of the auction, the computer system can update the auction listing and/or transmit notifications to bidders: to indicate that the auction will be successful; and to indicate that only bids at lower interest margins and/or shorter non-AMR periods (i.e., bids interest margins and non-AMR periods more favorable to the user) will be accepted during the remainder of this auction. The computer system can also recalculate this subset of bids—containing the lowest maximum interest margin and shortest maximum non-AMR period and that clear the outstanding debt quantity of the tranche—as subsequent bids are entered during the auction.

### 13. Settlement

Block S160 of the method S100 recites, in response to the sum of debt quantities clearing an outstanding debt quantity of the tranche upon conclusion of the online public auction, initiating settlement and redistribution of debt in the tranche to the set of broker-dealers (or investors more generally). Generally, in Block S160, if the aggregate debt quantity of a set of bids—placed during the auction and specifying a particular auction term—exceeds the outstanding debt quantity of the tranche, the computer system can handle settlement between these broker-dealers (or investors more generally) who placed these bids and debt holders who currently hold debt in the tranche, as shown in FIG. 5.

For example, in Block S160, the computer system (or the computer system in conjunction with an AMR agent, etc.) can: pool funds from broker-dealers who entered accepted bids; redistribute bonds from current debt holders to these broker-dealers (or the “new debt holders” for the tranche); compile identifiers of these new debt holders for the tranche; and send an update to the external trust and securities clearing service to update holding records for debt in the tranche. The computer system can also serve the interest margin and any non-AMR period for the cleared tranche to the external trust and securities clearing service and/or to the CLO trustee for recording. The computer system can similarly record an interest margin and a non-AMR period for the cleared tranche on the auction platform and reference this record to selectively withhold AMR for the particular tranche or for the CLO more generally until expiration of this non-AMR period.

### 14. Failed Auction

However, if the aggregate debt quantities submitted by broker-dealers at all auction terms fails to clear the tranche upon expiration of the auction, the computer system can interface with the user to revise an auction term (e.g., to higher interest margin and/or to a longer non-AMR period) for this tranche, as shown in FIG. 5. If the user confirms a new auction according to a revised auction term, the computer system can then repeat the foregoing methods and techniques to: update the election notice with this revised auction term; serve the updates election notice to the CLO trustee; initiate a new auction for the tranche according to the revised auction term, such as within ten business days of close of the prior failed auction; and initiate settlement for the tranche if the aggregate debt quantity—entered by broker-dealers according to this revised auction term—clears this tranche.

Alternatively, if the aggregate debt quantity submitted by broker-dealers at a particular auction term fails to clear a tranche, the computer system can market the remainder of the tranche at the current auction term to another broker-dealer on the auction platform, such as: a broker-dealer who submitted a bid at a slightly higher interest margin during the auction; or a preferred broker-dealer, such as selected by the user or automatically by the computer system. Yet alternatively, the computer system can automatically relist the remainder of the tranche in a second, “quick” auction (e.g., a one-day, or one-hour auction) in order to collect bids for the final remainder of the tranche, such as one hour after the earlier auction for the tranche concluded.

In another example, upon conclusion of an investor-controlled auction (and/or other auction formats described above), the computer system can identify a subset of entered bids that specify the lowest specified interest margins and that sum to (or more than) the outstanding debt quantity of the tranche. If at least a highest interest margin specified in this subset of bids exceeds a maximum interest margin assigned to the auction (e.g., set manually by the user, set automatically by the computer system based on the current interest margin of the tranche and a minimum interest margin reduction), the computer system can: withhold settlement and redistribution of the outstanding debt quantity in the tranche; transmit a query to the user to confirm settlement and redistribution of the outstanding debt quantity of the tranche according to this highest interest margin; initiate settlement as described above responsive to confirmation from the user. Additionally or alternatively, if at least a highest interest margin specified in this subset of bids exceeds a maximum interest margin assigned to the auction, the computer system can: extend a duration of the auction; transmit a query—to investors on the auction platform (or to investors who specifically placed bids during this auction)—to submit a new bid at an interest margin that clears (i.e., is less than or equal to) the maximum interest margin; record additional bids during this extended auction period; repeat the foregoing methods and techniques to identify a subset of bids entered during the primary and extended auction durations that clear requirements of the auction; and then initiate settlement and redistribution of the outstanding debt quantity in the tranche accordingly.

### 15. Failed Settlement

Furthermore, if a particular broker-dealer (or other individual debt investor) with an accepted bid in a successful auction for a tranche fails to post funds within a settlement period (e.g., one week), the computer system can re-market the unclaimed debt allocated to the particular broker-dealer. For example, the computer system can serve a private message or prompt to a second broker dealer for the unclaimed debt, such as: a broker-dealer who entered a bid for debt in the tranche at a slightly higher interest margin in the recent auction; or a favored broker-dealer selected by the user or selected automatically by the computer system. If this second broker-dealer confirms and posts funds for this debt, the computer system can complete settlement for the tranche as described above. If not, the computer system can automatically relist the unclaimed debt in the tranche in a second, “quick” auction in order to collect bids for this remainder of the tranche.

However, the computer system can implement any other method or technique to handle a failed auction or failed settlement for one or more tranches in the CLO and thus complete the AMR process for the CLO.

### 16. Multiple Concurrent Debt Tranche Auctions Within CLO

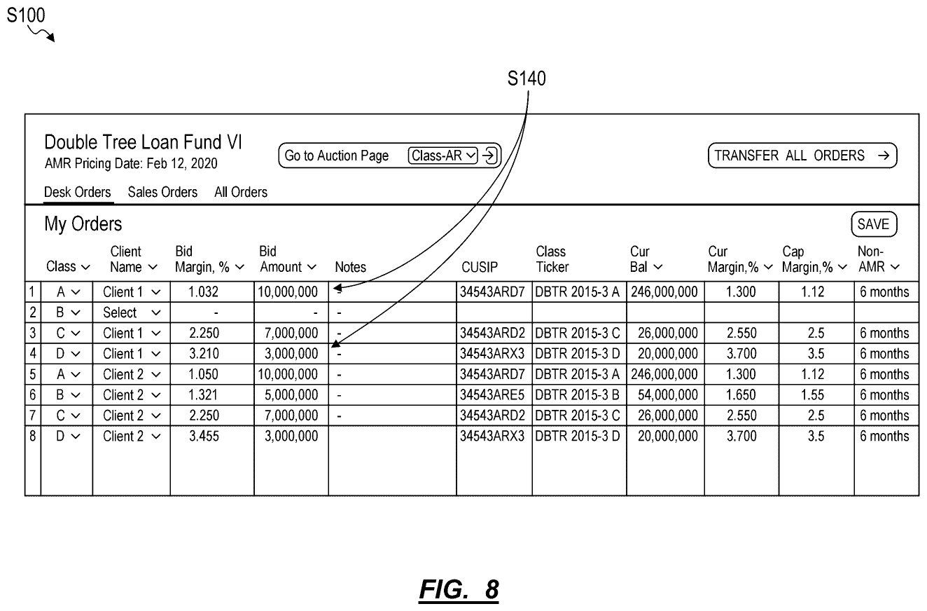

In one variation shown in FIGS. 1 and 2, the computer system can execute the foregoing methods and techniques to initiate, host, and settle multiple debt tranche auctions for multiple (or all) tranches within a CLO. For example, for a CLO with nine tranches (e.g., C, CC, CCC, B, BB, BBB, A, AA, and AAA tranches), the computer system can: interface with the user to assign one or a set of auction terms to each tranche; generate a single election notice containing data (e.g., auction terms, outstanding debt quantity, current interest margin, whitelisted and blacklisted broker-dealers) for all of these tranches or generate one election notice for each of these tranches; host concurrent auctions for each tranche on the auction platform; and then selectively initiate settlements for each tranche that received bids sufficient to clear the corresponding outstanding debt quantities at the corresponding auction term. For example, in this variation, the computer system can host a broker-dealer portal for a particular broker-dealer and populate the broker-dealer portal with bid parameters for bids placed by the broker-dealer for debt within one or more tranches of this CLO, such as including: an identifier of a investor on whose behalf the broker-dealer is bidding; a bid margin; a bid amount; and a tranche; etc. of the CLO, as shown in FIG. 8.

Alternately, the computer system can initiate consecutive auctions for selected tranches in this CLO. For example, the computer system can: initiate a first auction for a C-rated tranche; initiate a second auction for a CC-rated tranche as the first auction concludes; initiate a third auction for a CCC-rated tranche as the second auction concludes; and initiate a fourth auction for a B-rated tranche as the third auction concludes; etc. In another example, the computer system can score each selected tranche in the CLO as described above and then initiate auctions for these tranches in (reverse) order of score.

Furthermore, in this variation, the computer system can initiate concurrent or serial auctions—in different auction formats—for tranches in the same CLO. For example, the computer system can host: single-margin-option auctions for all C-rated tranches in the CLO; multiple-margin-option auctions for all B-rated tranches in the CLO; and investor-controlled auctions for all A-rated tranches in the CLO.

However, the computer system can host multiple concurrent or serial auctions for multiple or all tranches in a CLO according to any other auction terms.

### 17. Operating Environment

The method S100 for improving computational efficiency in a network-based auction platform (“auction platform”) can improve performance of the auction platform and associated computing devices by increasing auction efficiency and reducing computational drag and bandwidth consumption on the auction platform. Typical online auction platforms and exchanges (e.g., securities or options exchanges) may provide online markets for the sale of purchase and assets but with substantial consumption of electrical power and a significant computational and networking burdens on disparate user terminals, servers, and associated hardware.

Generally, the auction platform can execute Blocks of the method to enable users of disparate computing devices to sell and purchase goods or services according to a prescribed auction format, which increases computational efficiencies through streamlined auction practices throughout the auction platform. In particular, the method S100 can assist in the sale and purchase of illiquid assets (e.g., assets for which there is not readily available market pricing) such as antiques, art, certain non-fungible tokens (NFTs), selected types of non-exchange listed financial securities, or derivative assets of any of the foregoing.

The present invention can be embodied as a method, system, or computer program product. Accordingly, aspects of the invention can be implemented entirely in hardware, entirely in software (including firmware, resident software, micro-code, etc.), or in a combination of software and hardware. These implementations generally referred to herein as a “circuit,” “module,” or “system.” Furthermore, the present invention can be implemented as a computer program product on a computer-usable storage medium having computer-usable program code embodied in the medium.

For example, the method can be embodied in a computer-usable or computer-readable medium such as an electronic, magnetic, optical, electromagnetic, infrared, or semiconductor system, apparatus, or device. A non-exhaustive list of the computer-readable medium can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. A computer-usable or computer-readable medium can be any medium that can contain, store, communicate, or transport the program for use by or in connection with the instruction execution system, apparatus, or device.

Computer program code for carrying out operations of the present invention can be written in an object-oriented programming language such as Java, Smalltalk, C++ or the like. However, the computer program code for carrying out operations of the present invention can also be written in conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through a local area network (LAN) or a wide area network (WAN), or the connection can be made to an external computer (for example, through the internet using an Internet Service Provider).

Example implementations of the invention are described below with reference to flowchart illustrations and/or block diagrams of methods, apparatus (systems) and computer program products according to aspects of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Moreover, computer program instructions can also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

### 17.1 Computing Device

FIG. 1 is a block diagram of an exemplary computing device 100 in which the present invention can be utilized or implemented. Generally, the computing device 100 can include a processor 102. The processor 102 can be coupled to a system bus 104, which in turn can be coupled to a video adapter 108 and a display 110. Generally, the computer system bus 104 can be coupled to an Input/Output (I/O) bus 112, which in turn can be coupled to an I/O interface 114. The I/O interface 114 can facilitate wired or wireless communication with various I/O devices, including user interface (UI) devices such as a keyboard 116, a mouse 118, a trackpad 120, the display 110, speakers, microphones, etc.

Generally, the computing device 100 can include a network interface 130, which can be coupled to the computer system bus 104 and configured to connect the computing device 100 to a network 132. Generally, the network 132 can be an external network such as the internet, or an internal network such as a Virtual Private Network (VPN). Generally, the computing device 100 can utilize the network interface 130 and the network 130 to connect to, communicate with, and access data, software, or hardware assets (e.g., cloud computing or cloud storage services) on other computing devices 100 such as remote servers.

As shown in FIG. 1, the computing device 100 can also include a hard drive interface 140 that can interface with a hard drive 142. Generally, the hard drive 142 can read and write data to a system memory 144. Generally, the computer system memory 144 can include data such as the operating system (OS) 146 of the computing device 100 and software applications 148.

Generally, the software applications 148 can include a browser application 150 and email client 152. The browser application 150 and the email client 152 can include program modules and instructions enabling a client to send and receive network messages through the internet (e.g., through internet protocols), and communicate with one or more servers (e.g., web servers, email servers, etc.). Additionally. the software applications 148 can include an auction application 154 that can include software code for implementing the Blocks of the method S100.

### 17.2 Auction Platform

An auction platform can include an auction server, a set of user devices, including a set of bidder terminals and a set of seller terminals, and a set of financial or regulatory servers.

Generally, the auction server and the user device can be configured as a computing device 100 of the type described above. Alternatively, the auction server and the user device can be configured as a set or plurality of networked computing devices 100 of the type described above that collectively function as a unitary computing device 100.

Generally, a user (e.g., a seller or a bidder) interacts with the auction server via a user device to purchase and sell goods or services through an auction format, particularly goods and services for which there is little liquidity. The user device can include an information processing system such as a personal computer, a laptop computer, a tablet computer, a personal digital assistant (PDA), a smart phone, a mobile telephone, wearable computing device, or other device that is capable of communicating and processing data. The user device can be configured to present, render, or display a user interface to a bidder or a seller, and generally the information that is presented, rendered, or displayed to the respective bidder or seller can be determined in accordance with the Blocks of the method S100.

Generally, the user device is used to exchange information between a seller and a set of bidders via the auction server. For example, the user device can be used to configure an auction format at a seller terminal and to submit electronic bids during the auction at the bidder terminal. Generally, communication between the user devices and the auction server is accomplished via a network, such as the internet, a physical private network, a wireless network, a virtual private network (VPN), or a combination thereof.

Generally, the auction server can include an auction module that interprets and implements instructions for conducting an online auction. Additionally, the auction server can include a financial module that can connect to and communicate with a set of financial institutions (via the financial and regulatory servers) for the seller and the set of bidders. The auction server can also include a regulatory module that can connect to and communicate with a set of regulatory institutions (via the financial and regulatory servers), including, for example, securities exchange regulatory servers, taxation regulatory servers, and other government or international finance, banking, or reporting servers.

### 18. Security Protocols

The present disclosure describes a technically rigorous framework for managing the complexities of structured product investments. This framework leverages advanced encryption algorithms, blockchain technology, artificial intelligence models, and secure communication protocols. The technologies are executed by the computer system designed to achieve high standards of data integrity, verifiability, and operational reliability across auction workflows.

In one implementation, the computer system applies encryption protocols to protect data during storage and transmission. For example, the computer system can implement the Advanced Encryption Standard (AES) with a 256-bit key length to encrypt data at rest, such as investor profiles, tranche configurations, and bid metadata. The computer system can also protect data in transit by implementing the Transport Layer Security (TLS) 1.3, which mitigates risks of interception or tampering. To secure high-sensitivity transactions, such as proprietary bid submissions, the computer system can implement end-to-end encryption. In this example, the computer system encrypts bid data on the client side with the recipient's public key and decrypts it only with the corresponding private key.

Furthermore, the computer system records encryption actions within immutable audit logs, which provide a comprehensive record for compliance verification. Additionally, the computer system isolates cryptographic key material in hardware security modules (HSMs) to prevent unauthorized access. The computer system further implements key rotation policies and periodic audits to strengthen key management processes. The computer system also validates data integrity during encryption and decryption through hash-based verification, thereby ensuring all stored and transmitted data remains unaltered. To counteract brute force attacks, the computer system implements time-bound encryption key expiration policies, thereby rendering stolen data useless after key rotations. Therefore, the computer system creates a cryptographically secure environment that maintains the integrity and confidentiality of auction data.

In one variation, the computer system incorporates blockchain technology to construct an immutable and transparent ledger for all auction activities. For example, the computer system can log bid submissions, tranche allocations, and settlement confirmations on a distributed ledger implemented with Hyperledger Fabric. The computer system can construct private, permissioned networks that provide granular control over data access. The computer system can encode smart contracts within the blockchain to automate regulatory and operational rules, including bid validation, tranche-specific thresholds, and settlement workflows. To maintain transaction authenticity, the computer system can implement cryptographic hash functions to detect unauthorized modifications. Additionally, the computer system employs Merkle tree structures to validate transaction subsets efficiently without exposing the full dataset. The computer system integrates role-based access permissions directly into the ledger by embedding access control rules. The computer system logs every transaction with cryptographically verified timestamps, ensuring chronological traceability. The computer system also integrates block-level provenance to generate a complete history of all modifications within the blockchain. For example, if a malicious actor attempts to modify a bid record to inflate the bid amount fraudulently, the computer system detects the discrepancy in hash values across connected blocks and immediately invalidates the transaction. Therefore, the computer system establishes a tamper-proof and verifiable record of all transaction workflows.

As described above, the computer system enforces access control by implementing dynamic role-based permissions. In one implementation, the computer system can assign and verify user permissions through token-based authentication. For example, the computer system allows equity holders to access aggregated bid analytics while restricting bidders to their respective bid histories and tranche-related metrics. The computer system dynamically adjusts permissions as system configurations evolve, aligning functionality with user roles. The computer system applies multi-factor authentication (MFA) for critical actions, such as modifying auction parameters or accessing high-sensitivity data. The computer system logs all access events redundantly across multiple nodes to prevent unauthorized changes and maintain traceability. The computer system employs session management techniques to terminate inactive connections and reduce exposure to unauthorized access. The computer system implements real-time access pattern analysis to identify anomalies, such as attempts to escalate permissions or bypass role constraints. For example, if a hacker attempts to access restricted analytics dashboards by injecting malicious tokens, the computer system detects the anomaly through behavior analytics and automatically locks the account, notifying administrators for further investigation. Therefore, the computer system creates a secure operational environment tailored to role-specific requirements.

In one implementation, the computer system implements artificial intelligence (AI) to generate predictive insights and optimize auction processes. For example, the computer system can implement supervised machine learning models trained on historical auction data to forecast bidder behavior and recommend auction configurations that maximize outcomes. The computer system dynamically generates visualizations of tranche performance metrics, including bid activity, credit ratings, and interest rate dynamics, using real-time color-coded indicators. In this example, the computer system applies green hues to high-performing tranches and muted tones to underperforming tranches. The computer system also deploys unsupervised learning algorithms to detect anomalies in bidding patterns, identifying potential instances of fraudulent behavior. The computer system incorporates natural language processing (NLP) techniques to generate automated summaries of auction outcomes, presenting insights in a human-readable format. The computer system also employs reinforcement learning models to continuously refine bidding strategies based on real-time data. For example, if a malicious actor injects a sequence of bids designed to manipulate price levels, the computer system detects irregularities in bid timing and amounts, blocking further submissions and alerting the operator. Therefore, the computer system provides actionable insights that enhance decision-making and reduce operational complexity.

In one variation, the computer system enforces secure communication protocols to protect data exchanges across system endpoints. For example, the computer system can authenticate devices with unique cryptographic keys validated during each interaction. The computer system routes communications through dedicated API gateways that inspect and validate incoming and outgoing data. The computer system performs real-time traffic analysis to detect anomalies, such as distributed denial-of-service (DDoS) attacks, and applies immediate countermeasures. To further secure message queues for bid submissions, tranche updates, and notifications, the computer system employs RSA-2048 encryption. The computer system incorporates Perfect Forward Secrecy (PFS) to prevent retrospective decryption in cases of key compromise. The computer system implements redundant communication pathways and fallback mechanisms to maintain uninterrupted data flow during network disruptions. The computer system dynamically adjusts network bandwidth allocation to prioritize critical operations during high-traffic conditions. For example, during a high-value trade involving $5 billion in securities, the computer system identifies priority messages, such as final bid confirmations and settlement instructions, and reroutes non-critical communications to alternate channels, reducing latency and enhancing reliability. Therefore, the computer system establishes a robust communication framework that mitigates risks to data integrity and confidentiality.

The integration of encryption, blockchain, artificial intelligence, and secure communication protocols forms a cohesive operational framework for structured financial products. In one implementation, the computer system encrypts tranche details before transmitting them to authorized participants, records all transactions on a blockchain for immutable verification, and implements artificial intelligence to analyze bid activity and dynamically adjust auction parameters. The computer system recalibrates settlement protocols and performance thresholds based on real-time metrics, employing heuristic algorithms to fine-tune tranche configurations. The computer system incorporates predictive algorithms to anticipate auction challenges and preemptively adjust operational parameters. The computer system also integrates time-series analysis to monitor market trends and improve auction adaptability. For example, if a coordinated attack attempts to flood the system with invalid bids to destabilize pricing, the computer system detects the anomaly, invalidates the bids, and temporarily suspends bidding activity from flagged accounts. Therefore, the computer system resolves the inherent challenges of structured financial markets with precision and reliability.

In one implementation, the computer system anonymizes bidder identities by implementing advanced cryptographic techniques. For example, the computer system can generate ephemeral identifiers for each bidder and link these identifiers exclusively to bid metadata, excluding personally identifiable information. These identifiers are accessible only through authenticated blockchain queries. The computer system applies dual-layer encryption, combining AES-256 with RSA-2048, to create an additional layer of security for sensitive data. The computer system also implements differential privacy techniques to add statistical noise to aggregated data, enabling meaningful analysis without exposing individual contributions. The computer system logs all anonymization operations, providing a traceable record of identity obfuscation measures. The computer system applies zero-knowledge proof protocols to validate user actions without revealing underlying data. For example, when verifying bidder eligibility, the computer system confirms compliance with bid requirements without exposing the user's identity or personal details, preventing targeted attacks or fraud. Therefore, the computer system maintains data privacy while supporting robust analytical capabilities.

In one variation, the computer system automates settlement operations by implementing blockchain-integrated smart contracts. For example, the computer system can validate winning bids against predefined tranche thresholds encoded in smart contracts and execute ownership redistribution directly through blockchain updates. The computer system timestamps each transaction to preserve chronological integrity and implements distributed consensus protocols to validate settlements. The smart contracts incorporate contingency rules for addressing tie-breaking scenarios and partial settlements. The computer system monitors settlement execution through blockchain state changes, ensuring accurate completion of all transactions. The computer system integrates reconciliation workflows to handle discrepancies arising from network or data inconsistencies. For example, during a $5 billion securities trade, the computer system detects an inconsistency between submitted bids and recorded settlements, halts the process, and notifies administrators with the exact details for resolution. Therefore, the computer system performs reliable and automated settlement operations without requiring manual intervention.

In one implementation, the computer system adjusts auction parameters in real time based on market dynamics. For example, the computer system monitors bidder participation rates, submission times, and bid volumes to identify emerging trends. The computer system recalibrates interest rate caps and auction durations accordingly, notifying participants of updates through encrypted communication channels. The computer system employs reinforcement learning models to simulate auction scenarios and select configurations that optimize bidder engagement and tranche allocations. The computer system implements multi-objective optimization techniques to balance competing priorities, such as maximizing participation and maintaining bid diversity. The computer system incorporates automated feedback loops to refine auction strategies based on historical and real-time outcomes. For example, if market conditions suddenly shift, the computer system dynamically lowers tranche thresholds to encourage higher participation, preventing auction failure. Therefore, the computer system adapts effectively to fluctuating market conditions and improves auction outcomes.

In one variation, the computer system applies predictive analytics to model tranche demand. For example, the computer system implements regression models to estimate demand curves based on historical bidding behaviors, tranche characteristics, and macroeconomic indicators. These predictions inform the configuration of auction parameters, such as interest rate thresholds and non-reset periods, designed to maximize bidder participation. The computer system implements Bayesian inference techniques to quantify uncertainties in demand predictions, providing a robust foundation for decision-making. Post-auction, the computer system evaluates prediction accuracy and updates its models to improve alignment with market trends. The computer system applies ensemble learning methods to combine predictions from multiple models, enhancing accuracy and reliability. The computer system incorporates counterfactual analysis to evaluate alternative auction strategies and their potential impacts on outcomes. For example, the computer system simulates the effect of alternative interest caps during a high-stakes auction and provides recommendations for future implementations. Therefore, the computer system applies iterative refinements to sustain long-term alignment with dynamic market conditions.

In one implementation, the computer system integrates redundancy protocols to maintain operational continuity during network disruptions. For example, the computer system establishes dual communication channels for all critical transactions and switches to secondary pathways upon detecting anomalies in the primary channel. The computer system validates data integrity during failovers by implementing checksum methodologies and conducts regular failover simulations to verify disaster recovery readiness. The computer system incorporates predictive failure detection systems to proactively migrate operations before disruptions occur. The computer system monitors latency metrics across all channels to dynamically allocate resources and prevent bottlenecks. For example, during a high-volume trading session, the computer system detects increased latency and preemptively redistributes bandwidth to mitigate delays in settlement communications. Therefore, the computer system sustains reliable operations under adverse conditions.

In one variation, the computer system generates cryptographic identifiers for all transactional elements, thereby enabling granular traceability. For example, the computer system can generate identifiers for bids, tranches, and participant interactions and embed these identifiers within blockchain records. The computer system allows authorized users to query these identifiers to reconstruct detailed transaction histories. The computer system employs hierarchical indexing and advanced query optimization algorithms to support multi-parameter searches efficiently and without compromising security. The computer system integrates access patterns to refine index structures dynamically, optimizing query performance for high-frequency operations. The computer system applies homomorphic encryption for querying encrypted datasets, enabling secure data retrieval without compromising confidentiality. For example, the computer system facilitates secure audits during regulatory inspections without exposing sensitive bid data or account details, enhancing compliance without sacrificing security. Therefore, the computer system provides a scalable and efficient solution for auditability and compliance across all operational workflows.

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for managing an online public auction comprising:
by a computer system, hosting an electronic investor portal on a computer network;
receiving selection of a first tranche, in a set of tranches within a structured product investment, entered by an initiator at the electronic investor portal, the initiator affiliated with the structured product investment at a first time, the first tranche associated with an initial interest margin at the first time and containing a first outstanding debt quantity;
by the computer system, assigning a first cap margin, less than the initial interest margin, to the first tranche;
by the computer system, hosting a set of electronic bidding portals within an auction platform, the set of electronic bidding portals accessible to investors via computing devices over the computer network;
by the computer system, electronically publishing the online public auction, for the first outstanding debt quantity in the first tranche, on the auction platform;
initiating the online public auction on the auction platform;
in response to initiating the online public auction, setting a first timer for a first auction duration of the online public auction;
during the online public auction, recording a first set of electronic bids submitted by a first set of investors via the set of electronic bidding portals, each electronic bid in the first set of electronic bids specifying a debt quantity at the first cap margin;
by the computer system, calculating a first sum of debt quantities, at the first cap margin, specified in the first set of electronic bids; and
by the computer system, in response to the first sum of debt quantities falling below the first outstanding debt quantity of the first tranche at a second time prior to expiration of the first timer:
transmitting a first electronic notification indicating the first sum of debt quantities and failure to clear of the first outstanding debt quantity of the first tranche at the first cap margin to a subset of investors in the first set of investors;
by the computer system, in response to the first sum of debt quantities clearing the first outstanding debt quantity of the first tranche at a third time prior to expiration of the first timer:
transmitting a second electronic notification indicating clearance of the first outstanding debt quantity of the first tranche at the first cap margin to investors in the first set of investors;
automatically enabling submission of electronic bids, for debt in the first tranche, specifying interest margins less than the first cap margin;
serving notifications indicating enablement of electronic bids, for debt in the first tranche, specifying interest margins less than the first cap margin through the set of electronic bidding portals; and
following the third time during the online public auction, recording a second set of electronic bids submitted by a second set of investors via the auction platform, each electronic bid in the second set of electronic bids specifying a debt quantity at a second interest margin less than the first cap margin.

2. The method of claim 1:
wherein recording the first set of electronic bids comprises:
recording a first electronic bid submitted by a first investor via a first electronic bidding portal, the first electronic bid specifying a first preliminary debt quantity of at the first cap margin;
calculating a second outstanding debt quantity based on the first outstanding debt quantity and the first preliminary debt quantity; and
in response to the second outstanding debt quantity falling below a minimum bid quantity defined for the first tranche, automatically reducing the first preliminary debt quantity to a first final debt quantity, wherein a difference between the second outstanding debt quantity and the first final debt quantity is greater than the minimum bid quantity.

3. The method of claim 1:
wherein recording the first set of electronic bids comprises:
for each electronic bid in a first set of bids, by the computer system:
receiving the electronic bid, specifying the debt quantity at the first cap margin, from an investor associated with an investor identifier; and
generating a set of bid metadata identifying the investor, the debt quantity, and the first cap margin;
encrypting the set of bid metadata;
initiating generation of a block containing the set of bid metadata on a blockchain for storage on a distributed electronic ledger.

4. The method of claim 1, further comprising, by the computer system:
calculating a second sum of debt quantities, at the second interest margin less than the first cap margin, specified in the second set of electronic bids; and
initiating redistribution of the first outstanding debt quantity in the first tranche to investors in the first set of investors according to the first set of electronic bids:
in response to the first sum clearing the first outstanding debt quantity; and
in response to the second sum falling below the first outstanding debt quantity; and
initiating redistribution of the first outstanding debt quantity in the first tranche to investors in the second set of investors according to the second set of electronic bids:
in response to the second sum clearing the first outstanding debt quantity; and
based on the second interest margin falling below the first cap margin.

5. The method of claim 3, wherein initiating redistribution of the first outstanding debt quantity in the first tranche to investors in the first set of investors comprises:
generating a set of electronic commands to:
pool funds from the first set of investors associated with the first set of electronic bids; and
redistribute bonds from debt holders holding debt in the first tranche at the time to the first set of investors;
compiling a first set of digital identifiers of the first set of investors;
compiling the first set of digital identifiers and the first cap margin into an electronic prompt to update holding records for debt in the first tranche; and
transmitting the electronic prompt to a securities clearing service.

6. The method of claim 1, further comprising, by the computer system:
calculating a second sum of debt quantities, at the second interest margin less than the first cap margin, specified in the second set of electronic bids; and
in response to the second sum clearing the first outstanding debt quantity:
isolating a subset of electronic bids in the second set of electronic bids:
characterized by lowest interest margins across the second set of electronic bids; and
summing to a second debt quantity clearing the first outstanding debt quantity of the first tranche;
isolating a subset of investors, in the second set of investors, associated with the subset of electronic bids;
initiating redistribution of the first outstanding debt quantity in the first tranche to investors in the subset of investors according to the subset of electronic bids:

7. The method of claim 1:
wherein assigning the first cap margin to the first tranche comprises assigning the first cap margin to the first tranche in response to selection of the first cap margin by the initiator;
further comprising, following selection of the first tranche, by the computer system:
in response to expiration of a non-call period for the structured product investment and in response to absence of a non-reset period for the first tranche, generating an election notice for applicable margin reset of the first tranche based on a template election notice and structured product investment data extracted from an indenture of the structured product investment; and
serving the election notice to a trustee associated with the structured product investment for distribution to debt holders holding debt in the structured product investment; and
wherein initiating the online public auction comprises initiating the online public auction on the auction platform, for the first outstanding debt quantity in the first tranche, in response to receipt of verification from the trustee.

8. The method of claim 1, further comprising, by the computer system:
assigning a first non-reset period to the first tranche, the first non-reset period corresponding to a duration from settlement of the first outstanding debt quantity in the first tranche according to results of the online public auction to a next auction for debt in the first tranche in the structured product investment; and
during the online public auction, by the computer system:
monitoring a rate of electronic bid submission;
predicting failure of the online public auction in response to the rate of electronic bid submission falling below a threshold rate; and
in response to predicting failure of the online public auction:
calculating a second cap margin between the initial interest margin and the first cap margin;
calculating a second non-reset period greater than the first non-reset period; and
serving a prompt to the initiator to reset the online public auction with the second cap margin and the second non-reset period.

9. The method of claim 1:
further comprising defining a first non-reset period to the first tranche, the first non-reset period corresponding to a duration from settlement of the first outstanding debt quantity in the first tranche according to results of the online public auction to a next auction for debt in the first tranche in the structured product investment;
wherein assigning the first cap margin to the first tranche comprises assigning a first auction term specifying the first cap margin and the first non-reset period to the first tranche;
further comprising, by the computer system, assigning a third auction term to the first tranche, the third auction term specifying a third cap margin, less than the first cap margin, and a third non-reset period greater than the first non-reset period;
wherein recording the first set of electronic bids comprises recording the first set of electronic bids specifying debt quantities according to the first auction term;
further comprising, during the online public auction, recording a third set of electronic bids submitted by a third set of investors via the auction platform, each electronic bid in the third set of electronic bids specifying a debt quantity according to the third auction term;
further comprising:
by the computer system, calculating a second sum of debt quantities, at the second interest margin less than the first cap margin and greater than the second interest margin, specified in the second set of electronic bids; and
calculating a third sum of debt quantities specified in the third set of electronic bids submitted by the third set of investors during the online public auction; and
by the computer system:
initiating redistribution of the first outstanding debt quantity in the first tranche to investors in the first set of investors according to the first set of electronic bids:
in response to the first sum clearing the first outstanding debt quantity;
in response to the second sum falling below the first outstanding debt quantity; and
in response to the third sum falling below the first outstanding debt quantity; and
initiating redistribution of the first outstanding debt quantity in the first tranche to investors in the second set of investors according to the second set of electronic bids:
in response to the second sum clearing the first outstanding debt quantity;
in response to the third sum falling below the first outstanding debt quantity; and
based on the second interest margin falling below the first cap margin;

10. The method of claim 1:
further comprising:
prior to the online public auction, transmitting a query to a group of broker-dealers for interest margin preferences for the first tranche; and
calculating a target range of interest margins, less than the initial interest margin, based on a set of interest margin preferences received from the group of broker-dealers responsive to the query;
wherein assigning the first cap margin to the first tranche comprises:
prompting the initiator to select the first cap margin from the target range of interest margins;
assigning the first cap margin, selected from the target range of interest margins by the initiator, to the first tranche; and
wherein recording the first set of electronic bids comprises recording the first set of electronic bids submitted by the first set of investors in the group of broker-dealers.

11. The method of claim 1:
further comprising:
retrieving a set of maximum historical electronic bid amounts settled by investors in a population of investors;
populating a whitelist for the online public auction with a first identifier of a first investor in the population of investors;
calculating a first electronic bid limit for the first investor based on a function of a maximum electronic bid amount submitted and settled by the first investor for a second online public auction hosted on the auction platform prior to the online public auction;
assigning the first electronic bid limit to the first investor in the whitelist; and
wherein recording the first set of electronic bids comprises, during the online public auction, recording a first electronic bid, from a first investor in the first set of investors, limited to the first electronic bid limit assigned to the first investor in the whitelist.

12. The method of claim 1:
further comprising:
identifying a set of structured product investments designating a user as the initiator;
identifying a first subset of structured product investments, in the set of structured product investments, excluding pending non-call periods;
identifying a first subset of tranches, in the first subset of structured product investments, excluding pending non-reset periods; and
presenting the first subset of tranches to the user via the electronic investor portal accessed at a computing device; and
wherein receiving selection of the first tranche comprises receiving selection of the first tranche, in the first subset of tranches, from the user via the electronic investor portal.

13. The method of claim 12:
further comprising, for each tranche in the first subset of tranches, by the computer system:
retrieving a current interest margin of the tranche;
retrieving a recent interest margin settled for debt in a rating class equal to a rating of the tranche;
predicting a successful reset interest margin for the tranche based on the recent interest margin; and
calculating a score for the tranche based on a combination of an outstanding debt quantity of the tranche and the successful reset interest margin for the tranche;
wherein presenting the first subset of tranches to the user comprises presenting the first subset of tranches ordered by score within the electronic investor portal; and
further comprising, in response to receiving selection of the first tranche from the first subset of tranches at the electronic investor portal, serving a recommendation for a first successful reset interest margin, predicted for the first tranche, as the first cap margin for the first tranche.

14. The method of claim 1, further comprising:
receiving selection of a second tranche, in the set of tranches within the structured product investment, by the initiator, the second tranche associated with a second initial interest margin at the third time, containing a second outstanding debt quantity, and assigned a second rating class different from a first rating class of the first tranche;
assigning a second cap margin, less than the second initial interest margin, to the second tranche;
initiating a second online public auction on the auction platform for the second outstanding debt quantity in the second tranche;
during the second online public auction, recording a third set of electronic bids submitted by a third set of investors via the auction platform, each electronic bid in the third set of electronic bids specifying a debt quantity at the second cap margin;
calculating a second sum of debt quantities, at the second cap margin, specified in the third set of electronic bids; and
in response to the second sum of debt quantities clearing the second outstanding debt quantity of the second tranche upon conclusion of the second online public auction, initiating settlement and redistribution of the second outstanding debt quantity in the second tranche according to the third set of electronic bids.

15. The method of claim 1:
wherein assigning the first cap margin to the first tranche comprises assigning the first cap margin to the first tranche according to selection of a single-margin-option auction for the first tranche; and
further comprising:
receiving selection of a second tranche, in the set of tranches within the structured product investment, by the initiator, the second tranche associated with a second initial interest margin, containing a second outstanding debt quantity, and assigned a second rating class different from a first rating class of the first tranche;
receiving selection of an investor-controlled auction for the second tranche;
assigning a maximum interest margin, less than the second initial interest margin, to the second tranche according to the investor-controlled auction;
initiating a second online public auction on the auction platform for the second outstanding debt quantity in the second tranche;
during the second online public auction, recording a third set of electronic bids submitted by a third set of investors via the auction platform, each electronic bid in the third set of electronic bids specifying a debt quantity and an interest margin;
identifying a second subset of electronic bids, in the third set of electronic bids, that specify debt quantities:
summing to a second aggregate debt quantity that clears the second outstanding debt quantity; and
specifying interest margins skewed toward a lowest interest margin in the third set of electronic bids; and
in response to interest margins specified in the second subset of electronic bids clearing the maximum interest margin upon conclusion of the second online public auction, initiating settlement and redistribution of the second outstanding debt quantity in the second tranche according to the third set of electronic bids.

16. The method of claim 1:
wherein receiving selection of the first tranche comprises receiving selection of the structured product investment, comprising a set of tranches, by a user;
wherein initiating the online public auction for the first outstanding debt quantity in the first tranche comprises hosting the online public auction for the first outstanding debt quantity in the first tranche during a second period of time succeeding the first time; and
further comprising:
receiving selection of a second tranche, in the set of tranches within the structured product investment, by the initiator, the second tranche associated with a second initial interest margin at the first time, containing a second outstanding debt quantity, and assigned a second rating class different from a first rating class of the first tranche;
assigning a second cap margin, less than the second initial interest margin, to the second tranche;
hosting a second online public auction for the second outstanding debt quantity in the second tranche concurrently with the online public auction during the first period of time;
during the second online public auction, recording a third set of electronic bids submitted by a third set of investors via the auction platform, each electronic bid in the third set of electronic bids specifying a debt quantity at the second cap margin;
calculating a second sum of debt quantities, at the second interest margin less than the first cap margin, specified in the second set of electronic bids; and
calculating a third sum of debt quantities, at the second cap margin, specified in the third set of electronic bids; and
in response to the first sum clearing the first outstanding debt quantity and in response to the second sum falling below the first outstanding debt quantity:
initiating redistribution of the first outstanding debt quantity in the first tranche to investors in the first set of investors according to the first set of electronic bids:
in response to the second sum of debt quantities falling below the second outstanding debt quantity of the second tranche upon conclusion of the second online public auction:
preserving a distribution of the second outstanding debt quantity in the second tranche at the first time.

17. A method for managing an online public auction with a preselected set of bidders comprising:
by a computer system, receiving selection of a first tranche, in a set of tranches within a structured product investment, by an initiator affiliated with the structured product investment at a first time, the first tranche associated with an initial interest margin at the first time and containing a first outstanding debt quantity;
by the computer system, assigning a first cap margin, less than the initial interest margin, to the first tranche;
by the computer system,
for each investor in a population of investors:
accessing an electronic profile associated with the investor;
retrieving a maximum historical electronic bid amount, settled by the investor, from the electronic profile;
calculating an electronic bid limit for the investor based on a function of a maximum electronic bid amount submitted and settled by the investor for online public auctions hosted on an auction platform prior to the online public auction;
representing the investor in a whitelist;
assigning the electronic bid limit to the investor in the whitelist;
by the computer system, initiating the online public auction on the auction platform for the first outstanding debt quantity in the first tranche;
during the online public auction, recording a first set of electronic bids submitted via the auction platform, each electronic bid in the first set of electronic bids:
received from a particular investor represented in the whitelist;
specifying a debt quantity at the first cap margin; and
specifying a bid value within the electronic bid limit assigned to the particular investor in the whitelist;
by the computer system, calculating a first sum of debt quantities, at the first cap margin, specified in the first set of electronic bids; and
in response to the first sum of debt quantities clearing the first outstanding debt quantity of the first tranche upon conclusion of the online public auction, initiating settlement and redistribution of the first outstanding debt quantity in the first tranche according to the first set of electronic bids.

18. The method of claim 17:
wherein recording the first set of electronic bids comprises recording the first set of electronic bids submitted by a first set of investors, in the population of investors, via the auction platform;
further comprising:
in response to initiating the online public auction, initiating a timer for an auction duration; and
in response to the first sum of debt quantities clearing the first outstanding debt quantity of the first tranche at a second time prior to expiration of the first timer:
transmitting an electronic notification indicating clearance of the first outstanding debt quantity of the first tranche at the first cap margin to investors in the first set of investors;
transmitting an electronic notification indicating clearance of the first outstanding debt quantity of the first tranche at the first cap margin to investors in the first set of investors;
automatically enabling submission of electronic bids, for debt in the first tranche, specifying interest margins less than the first cap margin from investors represented in the whitelist;
serving notifications indicating enablement of electronic bids, for debt in the first tranche, specifying interest margins less than the first cap margin through the auction platform; and
following the second time during the online public auction, recording a second set of electronic bids submitted by a second set of investors, in the population of investors, via the auction platform, each electronic bid in the second set of electronic bids specifying a debt quantity at a second interest margin less than the first cap margin.

19. The method of claim 17, wherein initiating settlement and redistribution of the first outstanding debt quantity comprises:
calculating a first sum of debt quantities, at the first cap margin, specified in the first set of electronic bids; and
calculating a second sum of debt quantities, at the second interest margin less than the first cap margin, specified in the second set of electronic bids; and
initiating redistribution of the first outstanding debt quantity in the first tranche to investors in the first set of investors according to the first set of electronic bids:
in response to the first sum clearing the first outstanding debt quantity; and
in response to the second sum falling below the first outstanding debt quantity.

20. A method for managing an online public auction comprising:
by a computer system, hosting an electronic investor portal on a computer network;
receiving selection of a first tranche and a second tranche, in a set of tranches within a structured product investment, entered by an initiator at the electronic investor portal:
the initiator affiliated with the structured product investment at a first time;
the first tranche associated with a first initial interest margin at the first time, containing a first outstanding debt quantity, and assigned a first rating class; and
the second tranche associated with a second initial interest margin at the first time, containing a second outstanding debt quantity, and assigned a second rating class different from the first rating class;
by the computer system, assigning a first cap margin, less than the first initial interest margin, to the first tranche;
by the computer system, assigning a second cap margin, less than the second initial interest margin, to the second tranche;
by the computer system, hosting a set of electronic bidding portals within an auction platform, the set of electronic bidding portals accessible to investors via computing devices over a computer network;
by the computer system, electronically publishing an online public auction, for the first outstanding debt quantity in the first tranche and the second outstanding debt quantity in the second tranche, on the auction platform during a first time period;
initiating the online public auction on the auction platform;
during the online public auction:
recording a first set of electronic bids submitted by a first set of investors via the set of electronic bidding portals, each electronic bid in the first set of electronic bids specifying a debt quantity at a first interest margin less than the first cap margin for the first tranche; and
recording a second set of electronic bids submitted by a second set of investors via the set of electronic bidding portals, each electronic bid in the second set of electronic bids specifying a debt quantity at a second interest margin less than the second cap margin for the second tranche;
calculating a first sum of debt quantities, less than the first cap margin, specified in the first set of electronic bids;
calculating a second sum of debt quantities, less than the second cap margin, specified in the second set of electronic bids; and
in response to the first sum clearing the first outstanding debt quantity upon conclusion of the online public auction:
initiating redistribution of the first outstanding debt quantity in the first tranche to investors in the first set of investors according to the first set of electronic bids; and
in response to the second sum of debt quantities falling below the second outstanding debt quantity of the second tranche upon conclusion of the online public auction:
preserving a distribution of the second outstanding debt quantity in the second tranche prior to online public auction.
